(19) United States
(12) Patent Application Publication
(10) Pub. No.: US 2023/0052192 A1
(43) Pub. Date: Feb. 16, 2023

(54) NON-TRANSITORY COMPUTER READABLE MEDIUM AND METHOD FOR STYLE TRANSFER

(71) Applicant: SQUARE ENIX CO., LTD., Tokyo (JP)

(72) Inventors: Edgar Handy, Tokyo (JP); Youichiro Miyake, Tokyo (JP); Shinpei Sakata, Tokyo (JP)

(73) Assignee: SQUARE ENIX CO., LTD., Tokyo (JP)

(21) Appl. No.: 17/815,311

(22) Filed: Jul. 27, 2022

(30) Foreign Application Priority Data
Jul. 28, 2021 (JP) 2021-123760

(51) Int. Cl. G06T 11/00; G06T 7/11; G06T 7/73; G06T 3/00; A63F 13/52

(52) U.S. Cl. CPC G06T 11/001; G06T 7/11; G06T 7/73; G06T 3/0006; A63F 13/52; G06T 2207/20076; G06T 2207/20084

(57) ABSTRACT

According to one or more embodiments, a non-transitory computer readable medium storing a program which, when executed, causes a computer to perform processing comprising acquiring image data, applying style transfer to the image data a plurality of times based on one or more style images, and outputting data after the style transfer is applied.

### CROSS-REFERENCE TO RELATED APPLICATION(S)

This application claims priority to and the benefit of Japanese Patent Application No. 2021-123760 filed on Jul. 28, 2021, the disclosures of which are incorporated herein by reference in its entirety for any purpose.

### BACKGROUND

A technology of style transfer for transforming a photo image into an image corresponding to a predetermined style, such as Gogh style or Monet style, is known. JP-A-2020-187583 discloses style transformation (that is style transfer).

Style transfer in the related art transforms the entirety of an input image into a predetermined style such as Monet style. However, it is considered that the range of representational power is narrow by simply transforming the input image into the predetermined style. In addition, it is not possible to perform flexible style transfer with rich representational power, such as transforming a portion of the input image to one style and another portion to another style. Furthermore, an image after applying the style transfer is composed of colors based on the colors of the style image, and thus it is not possible to perform dynamic control between the colors of the original image (may also be referred to as a content image) and the colors of the style image. From this viewpoint, the image after applying the style transfer does not have rich representational power.

Hence, there is a need for a non-transitory computer readable medium storing a program for style transfer, a method for style transfer, a system or an apparatus for style transfer, and the like that can solve the above problems and achieve style transfer with rich representational power.

### SUMMARY

From a non-limiting viewpoint, according to one or more embodiments of the disclosure, there is provided a non-transitory computer readable medium storing a program which, when executed, causes a computer to perform processing comprising acquiring image data, applying style transfer to the image data a plurality of times based on one or more style images, and outputting data after the style transfer is applied.

From a non-limiting viewpoint, one or more embodiments of the disclosure provide a method comprising acquiring image data, applying style transfer to the image data a plurality of times based on one or more style images, and outputting data after the style transfer is applied.

### BRIEF DESCRIPTION OF THE DRAWINGS

FIG. 1 is a block diagram of a configuration of a video game processing system according to at least one embodiment of the disclosure.

FIG. 2 is a block diagram of a configuration of a server according to at least one embodiment of the disclosure.

FIG. 3 is a flowchart of processing of a style transfer program according to at least one embodiment of the disclosure.

FIG. 4 is a block diagram of a configuration of a server according to at least one embodiment of the disclosure.

FIG. 5 is a flowchart of processing of a style transfer program according to at least one embodiment of the disclosure.

FIG. 6 is a block diagram of a configuration of a server according to at least one embodiment of the disclosure.

FIG. 7 is a flowchart of processing of a style transfer program according to at least one embodiment of the disclosure.

FIG. 8 is a block diagram of a configuration of a server according to at least one embodiment of the disclosure.

FIG. 9 is a flowchart of processing of a style transfer program according to at least one embodiment of the disclosure.

FIG. 10 is a block diagram of a configuration of a server according to at least one embodiment of the disclosure.

FIG. 11 is a flowchart of processing of a style transfer program according to at least one embodiment of the disclosure.

FIG. 12 is a block diagram of a configuration of a server according to at least one embodiment of the disclosure.

FIG. 13 is a flowchart of processing of a style transfer program according to at least one embodiment of the disclosure.

FIG. 14 is a conceptual diagram of a structure of a neural network for style transfer according to at least one embodiment of the disclosure.

FIG. 15 is a conceptual diagram of a structure of a neural network for style transfer according to at least one embodiment of the disclosure.

FIG. 16 is a flowchart of an optimization process according to at least one embodiment of the disclosure.

FIG. 17 is a conceptual diagram of a process of repeatedly applying style transfer a plurality of times according to at least one embodiment of the disclosure.

FIG. 18 is a conceptual diagram of a process of repeatedly applying style transfer a plurality of times according to at least one embodiment of the disclosure.

FIG. 19 is a conceptual diagram of a process of repeatedly applying style transfer a plurality of times according to at least one embodiment of the disclosure.

FIG. 20 is a block diagram of a configuration of a server according to at least one embodiment of the disclosure.

FIG. 21 is a flowchart of processing of a style transfer program according to at least one embodiment of the disclosure.

FIG. 22 is a conceptual diagram of a structure of a neural network for style transfer using a mask according to at least one embodiment of the disclosure.

FIG. 23 is a conceptual diagram of a mask for style transfer according to at least one embodiment of the disclosure.

FIG. 24 is a conceptual diagram of a method of calculating a parameter for normalization to be performed in a processing layer according to at least one embodiment of the disclosure.

FIG. 25 is a conceptual diagram of a method of calculating a parameter for normalization to be performed in a processing layer according to at least one embodiment of the disclosure.

FIG. 26 is a conceptual diagram of normalization to be performed in a processing layer according to at least one embodiment of the disclosure.

FIG. 27 is a conceptual diagram of an affine transformation process after normalization according to at least one embodiment of the disclosure.

FIG. 28 is a conceptual diagram of a style transfer process using a mask according to at least one embodiment of the disclosure.

FIG. 29 is a conceptual diagram of a style transfer process using a mask according to at least one embodiment of the disclosure.

FIG. 30 is a conceptual diagram of a mask for dividing image data into three regions and applying different styles to the respective regions according to at least one embodiment of the disclosure.

FIG. 31 is a conceptual diagram of normalization to be performed in a processing layer according to at least one embodiment of the disclosure.

FIG. 32 is a conceptual diagram of an affine transformation process after normalization according to at least one embodiment of the disclosure.

FIG. 33 is a block diagram of a configuration of a server according to at least one embodiment of the disclosure.

FIG. 34 is a flowchart of processing of a style transfer program according to at least one embodiment of the disclosure.

FIG. 35 is a conceptual diagram of a method of training a style transfer network according to at least one embodiment of the disclosure.

FIG. 36 is a conceptual diagram of a configuration of a style vector according to at least one embodiment of the disclosure.

FIG. 37 is a conceptual diagram of a method of training a style transfer network according to at least one embodiment of the disclosure.

FIG. 38 is a conceptual diagram of a configuration of a style vector according to at least one embodiment of the disclosure.

FIG. 39 is a conceptual diagram of part of a method of training a style transfer network according to at least one embodiment of the disclosure.

FIG. 40 is a conceptual diagram of calculating an RGB optimization function in an RGB branch according to at least one embodiment of the disclosure.

FIG. 41 is a conceptual diagram of calculating a YUV optimization function in a YUV branch according to at least one embodiment of the disclosure.

FIG. 42 is a conceptual diagram of an optimization function in style transfer that dynamically controls colors according to at least one of the embodiments of the disclosure.

FIG. 43 is a conceptual diagram of calculating an RGB optimization function in an RGB branch according to at least one embodiment of the disclosure.

FIG. 44 is a conceptual diagram of calculating a YUV optimization function in a YUV branch according to at least one embodiment of the disclosure.

FIG. 45 is a conceptual diagram of an optimization process according to at least one embodiment of the disclosure.

FIG. 46 is a conceptual diagram of dynamic (runtime) color control by a processor according to at least one embodiment of the disclosure.

### DESCRIPTION OF EMBODIMENTS

Hereinafter, certain example embodiments of the disclosure will be described with reference to the accompanying drawings. Various constituents in the example embodiments described herein may be appropriately combined without contradiction to each other or the like and without departing from the scope of the disclosure. Some contents described as an example of a certain embodiment may be omitted in descriptions of other embodiments. An order of various processes that form various flows or sequences described herein may be changed without creating contradiction or the like in process contents and without departing from the scope of the disclosure.

### First Embodiment

An example of a style transfer program to be executed in a server that is an example of a computer will be described as a first embodiment.

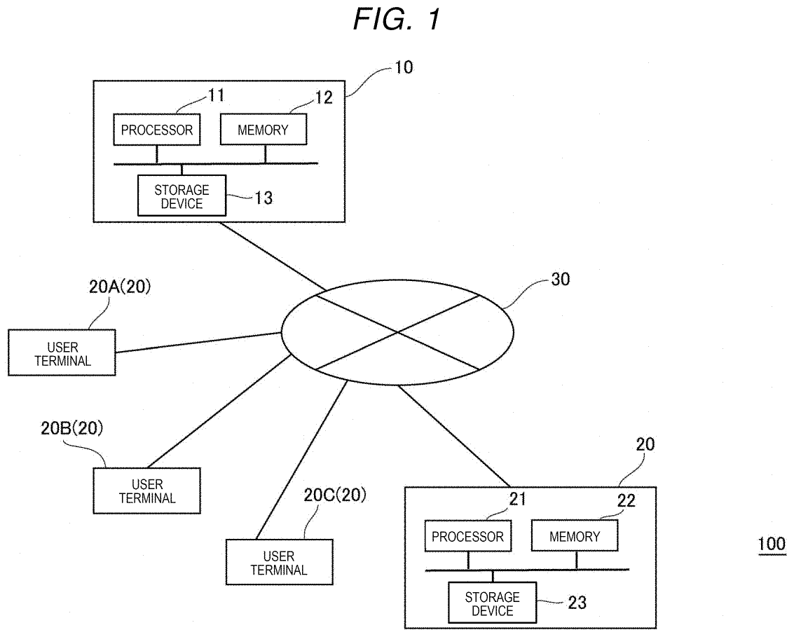

FIG. 1 is a block diagram of a configuration of a video game processing system 100 according to the first embodiment. The video game processing system 100 includes a video game processing server 10 (server 10) and a user terminal 20 used by a user (for example, a player or the like of a game) of the video game processing system 100. Each of user terminals 20A, 20B, and 20C is an example of the user terminal 20. The configuration of the video game processing system 100 is not limited thereto. For example, the video game processing system 100 may have a configuration in which a plurality of users use a single user terminal. The video game processing system 100 may include a plurality of servers.

The server 10 and the user terminal 20 are examples of computers. Each of the server 10 and the user terminal 20 is communicably connected to a communication network 30, such as the Internet. Connection between the communication network 30 and the server 10 and connection between the communication network 30 and the user terminal 20 may be wired connection or wireless connection. For example, the user terminal 20 may be connected to the communication network 30 by performing data communication with a base station managed by a communication service provider by using a wireless communication line.

Since the video game processing system 100 includes the server 10 and the user terminal 20, the video game processing system 100 implements various functions for executing various processes in accordance with an operation of the user.

The server 10 controls progress of a video game. The server 10 is managed by a manager of the video game processing system 100 and has various functions for providing information related to various processes to a plurality of user terminals 20.

The server 10 includes a processor 11, a memory 12, and a storage device 13. For example, the processor 11 is a central processing device, such as a central processing unit (CPU), that performs various calculations and controls. In a case where the server 10 includes a graphics processing unit (GPU), the GPU may be set to perform some of the various calculations and controls. In the server 10, the processor 11 executes various types of information processes by using data read into the memory 12 and stores obtained process results in the storage device 13 as needed.

The storage device 13 has a function as a storage medium that stores various types of information. The configuration of the storage device 13 is not particularly limited. From a viewpoint of reducing a process load applied to the user terminal 20, the storage device 13 may have a configuration capable of storing all types of various types of information necessary for controls performed in the video game processing system 100. Such examples include an HDD and an SSD. The storage device that stores various types of information may have a storage region in an accessible state from the server 10, and, for example, may be configured to have a dedicated storage region outside the server 10.

The server 10 may be configured with an information processing apparatus, such as a game server, that can render a game image.

The user terminal 20 is managed by the user and comprises a communication terminal capable of performing a network distribution type game. Examples of the communication terminal capable of performing the network distribution type game include but are not limited to a mobile phone terminal, a personal digital assistant (PDA), a portable game apparatus, VR goggles, AR glasses, smart glasses, and a so-called wearable apparatus. The configuration of the user terminal that may be included in the video game processing system 100 is not limited thereto and may have a configuration in which the user may recognize a combined image. Other examples of the configuration of the user terminal include but are not limited to a combination of various communication terminals, a personal computer, and a stationary game apparatus.

The user terminal 20 is connected to the communication network 30 and includes hardware (for example, a display device that displays a browser screen corresponding to coordinates or a game screen) and software for executing various processes by communicating with the server 10. Each of a plurality of user terminals 20 may be configured to be capable of directly communicating with each other without the server 10.

The user terminal 20 may incorporate a display device. The display device may be connected to the user terminal 20 in a wireless or wired manner. The display device may have a general configuration and thus is not separately illustrated. For example, the game screen is displayed as the combined image by the display device, and the user recognizes the combined image. For example, the game screen is displayed on a display that is an example of the display device included in the user terminal, or a display that is an example of the display device connected to the user terminal. Examples of the display device include but are not limited to a hologram display device capable of performing hologram display, and a projection device that projects images (including the game screen) to a screen or the like.

The user terminal 20 includes a processor 21, a memory 22, and a storage device 23. For example, the processor 21 is a central processing device, such as a central processing unit (CPU), that performs various calculations and controls. In a case where the user terminal 20 includes a graphics processing unit (GPU), the GPU may be set to perform some of the various calculations and controls. In the user terminal 20, the processor 21 executes various types of information processes by using data read into the memory 22 and stores obtained process results in the storage device 23 as needed. The storage device 23 has a function as a storage medium that stores various types of information.

The user terminal 20 may incorporate an input device. The input device may be connected to the user terminal 20 in a wireless or wired manner. The input device receives an operation input provided by the user. The processor included in the server 10 or the processor included in the user terminal 20 executes various control processes in accordance with the operation input provided by the user. Examples of the input device include but are not limited to a touch panel screen included in a mobile phone terminal or a controller connected to AR glasses in a wireless or wired manner. A camera included in the user terminal 20 may correspond to the input device. The user provides the operation input (such as gesture input) by a gesture such as moving a hand in front of the camera.

The user terminal 20 may further include another output device such as a speaker. The other output device outputs voice or other various types of information to the user.

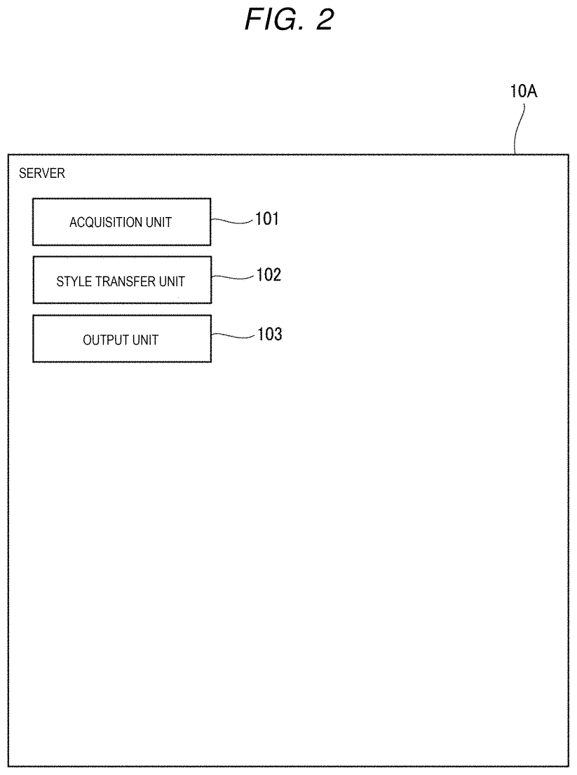

FIG. 2 is a block diagram of a configuration of a server 10A according to the first embodiment. The server 10A is an example of the server 10 and includes at least an acquisition unit 101, a style transfer unit 102, and an output unit 103. A processor included in the server 10A functionally implements the acquisition unit 101, the style transfer unit 102, and the output unit 103 by referring to a style transfer program stored in the storage device and executing the style transfer program.

The acquisition unit 101 has a function of acquiring image data. The style transfer unit 102 has a function of applying style transfer based on one or more style images to the image data one or more times. The style transfer unit 102 may repeatedly apply the style transfer to the image data a plurality of times based on one or more style images. The output unit 103 has a function of outputting data after the style transfer is applied.

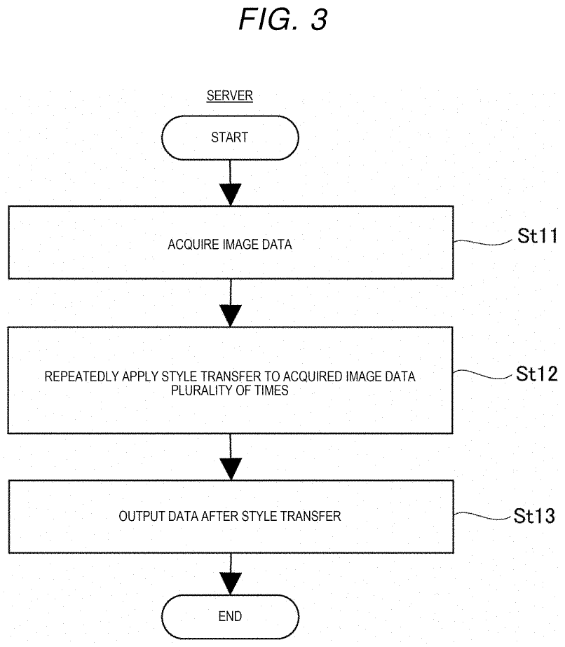

Next, program execution processing in the first embodiment will be described. FIG. 3 is a flowchart of processing of the style transfer program according to the first embodiment.

The acquisition unit 101 acquires image data (St11). The style transfer unit 102 repeatedly applies the style transfer to the image data a plurality of times based on one or more style images (St12). The output unit 103 outputs the data after the style transfer is applied (St13).

The acquisition source of the image data by the acquisition unit 101 may be a storage device to which the acquisition unit 101 is accessible. The acquisition unit 101 may acquire image data, for example, from the memory 12 or the storage device 13 provided in the server 10A. The acquisition unit 101 may acquire image data from an external device via the communication network 30. Examples of the external device include the user terminal 20 and other servers, but are not limited thereto.

The acquisition unit 101 may acquire the image data from a buffer used for rendering. The buffer used for rendering includes, for example, a buffer used by a rendering engine having a function of rendering a three-dimensional CG image.

A style includes, for example, a mode or a type in construction, art, music, or the like. For example, the style may include a painting style, such as Gogh style or Picasso style. The style may include a format (for example, a color, a predetermined design, or a pattern) of an image. A style image includes an image (such as a still image or a moving image) having a specific style.

The style transfer unit 102 may use a neural network for the style transfer. For example, related technologies include Vincent Dumoulin, et. al. “A LEARNED REPRESENTATION FOR ARTISTIC STYLE”. An output image to which the style transfer has been applied can be obtained by causing the style transfer unit 102 to input an input image of a predetermined size into the neural network.

An output destination of the data after application of the style transfer, by the output unit 103, may be a buffer different from the buffer from which the acquisition unit 101 acquires the image data. For example, in a case where the buffer from which the acquisition unit 101 acquires the image data is set to a first buffer, the output destination of the data after application of the style transfer may be set to a second buffer different from the first buffer. The second buffer may be a buffer used after the first buffer in a rendering process.

In addition, the output destination of the data after application of the style transfer, by the output unit 103, may be the storage device or the output device included in the server 10A or an external device seen from the server 10A.

As an aspect of the first embodiment, it is possible to flexibly apply a style image group configured by one or more style images and widen the range of representational power.

### Second Embodiment

An example of a style transfer program to be executed in a server that is an example of a computer will be described as a second embodiment. The server may be the server 10 included in the video game processing system 100 illustrated in FIG. 1.

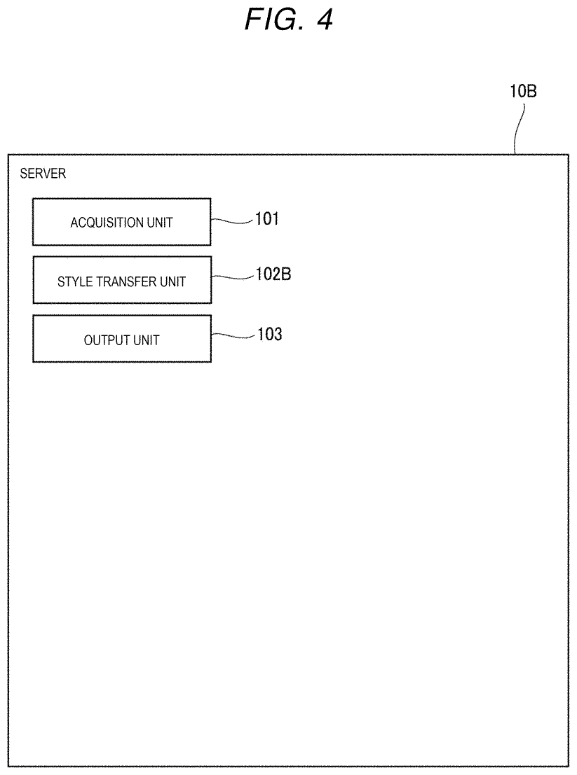

FIG. 4 is a block diagram of a configuration of a server 10B according to the second embodiment. The server 10B is an example of the server 10 and includes at least an acquisition unit 101, a style transfer unit 102B, and an output unit 103. A processor included in the server 10B functionally implements the acquisition unit 101, the style transfer unit 102B, and the output unit 103 by referring to a style transfer program stored in a storage device and executing the style transfer program.

The acquisition unit 101 has a function of acquiring image data. The style transfer unit 102B has a function of applying style transfer to the image data one or more times based on one or more style images. The style transfer unit 102B may repeatedly apply the style transfer to the image data a plurality of times based on one or more style images. In this case, the style transfer unit 102B may repeatedly apply the style transfer to the image data based on one or more style images that are the same as those used for the style transfer already applied to the image data. The output unit 103 has a function of outputting data after the style transfer is applied.

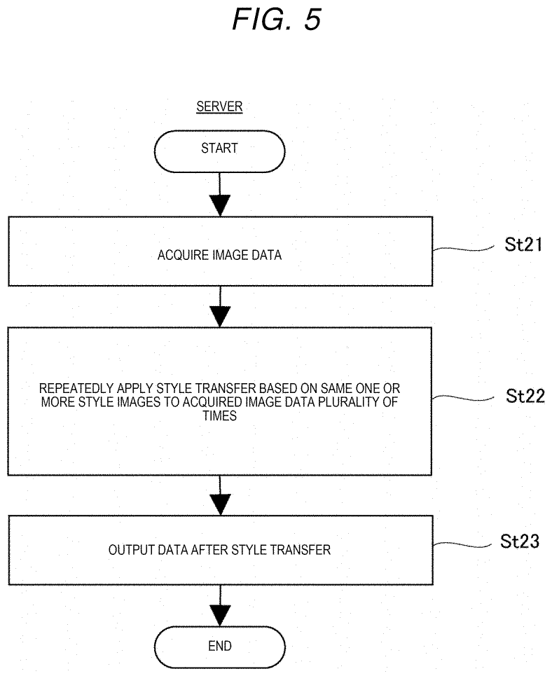

Next, program execution processing in the second embodiment will be described. FIG. 5 is a flowchart of processing of the style transfer program according to the second embodiment.

The acquisition unit 101 acquires image data (St21). The style transfer unit 102B repeatedly applies the style transfer based on one or more style images to the image data a plurality of times (St22). In Step St22, the style transfer unit 102B repeatedly applies the style transfer to the image data based on one or more style images that are the same as those used for the style transfer already applied to the image data. The output unit 103 outputs the data after the style transfer is applied (St23).

The acquisition source of the image data by the acquisition unit 101 may be a storage device to which the acquisition unit 101 is accessible. For example, the acquisition unit 101 may acquire image data from the memory 12 or the storage device 13 provided in the server 10B. The acquisition unit 101 may acquire image data from an external device via a communication network 30. Examples of the external device include the user terminal 20 and other servers, but are not limited thereto.

The acquisition unit 101 may acquire the image data from a buffer used for rendering. The buffer used for rendering includes, for example, a buffer used by a rendering engine having a function of rendering a three-dimensional CG image.

A style includes, for example, a mode or a type in construction, art, music, or the like. For example, the style may include a painting style such as Gogh style or Picasso style. The style may include a format (for example, a color, a predetermined design, or a pattern) of an image. A style image includes an image (such as a still image or a moving image) drawn in a specific style.

The style transfer unit 102B may use a neural network for the style transfer. For example, related technologies include Vincent Dumoulin, et. al. “A LEARNED REPRESENTATION FOR ARTISTIC STYLE”. An output image to which the style transfer is applied can be obtained by causing the style transfer unit 102B to input an input image of a predetermined size into the neural network.

An output destination of the data after application of the style transfer, by the output unit 103, may be a buffer different from the buffer from which the acquisition unit 101 acquires the image data. For example, in a case where the buffer from which the acquisition unit 101 acquires the image data is set to a first buffer, the output destination of the data after application of the style transfer may be set to a second buffer different from the first buffer. The second buffer may be a buffer used after the first buffer in a rendering process.

In addition, the output destination of the data after application of the style transfer, by the output unit 103, may be the storage device or the output device included in the server 10B or an external device seen from the server 10B.

As an aspect of the second embodiment, since the style transfer based on one or more style images that are the same as style images used in the style transfer applied already to the image data is repeatedly applied to the image data, it is possible to obtain an output image with more emphasized features of the style image and stronger deformation.

### Third Embodiment

An example of a style transfer program to be executed in a server that is an example of a computer will be described as a third embodiment. The server may be the server 10 included in the video game processing system 100 illustrated in FIG. 1.

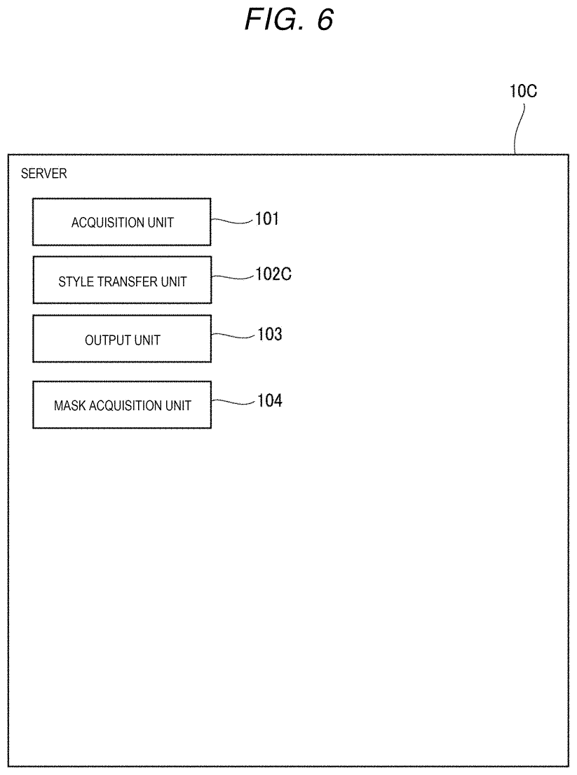

FIG. 6 is a block diagram of a configuration of a server 10C according to the third embodiment. The server 10C is an example of the server 10 and includes at least the acquisition unit 101, a style transfer unit 102C, the output unit 103, and a mask acquisition unit 104. A processor included in the server 10C functionally implements the acquisition unit 101, the style transfer unit 102C, the output unit 103, and the mask acquisition unit 104 by referring to a style transfer program stored in a storage device and executing the style transfer program.

The acquisition unit 101 has a function of acquiring image data. The style transfer unit 102C has a function of applying style transfer to the image data one or more times based on one or more style images. The style transfer unit 102C may repeatedly apply the style transfer to the image data a plurality of times based on one or more style images. The output unit 103 has a function of outputting data after the style transfer is applied. The mask acquisition unit 104 has a function of acquiring a mask for suppressing the style transfer in a partial region of the image data. The style transfer unit 102C has a function of applying style transfer based on one or more style images to the image data by using the mask.

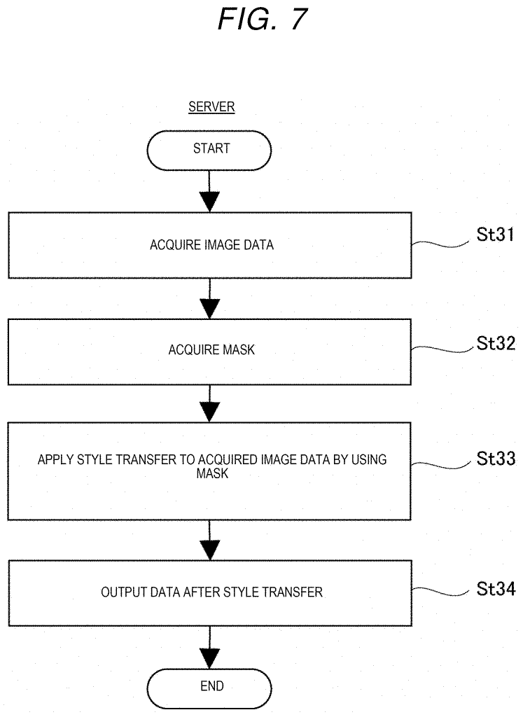

Next, program execution processing in the third embodiment will be described. FIG. 7 is a flowchart of processing of the style transfer program according to the third embodiment.

The acquisition unit 101 acquires image data (St31). The mask acquisition unit 104 acquires a mask for suppressing the style transfer in a partial region of the image data (St32). The style transfer unit 102C applies the style transfer to the image data by using the mask, based on one or more style images (St33). The output unit 103 outputs the data after the style transfer is applied (St34).

The acquisition source of the image data by the acquisition unit 101 may be a storage device to which the acquisition unit 101 is accessible. For example, the acquisition unit 101 may acquire image data from the memory 12 or the storage device 13 provided in the server 10C. The acquisition unit 101 may acquire image data from an external device via a communication network 30. Examples of the external device include the user terminal 20 and other servers, but are not limited thereto.

The acquisition unit 101 may acquire the image data from a buffer used for rendering. The buffer used for rendering includes, for example, a buffer used by a rendering engine having a function of rendering a three-dimensional CG image.

A style includes, for example, a mode or a type in construction, art, music, or the like. For example, the style may include a painting style such as Gogh style or Picasso style. The style may include a format (for example, a color, a predetermined design, or a pattern) of an image.

A style image includes an image (such as a still image or a moving image) drawn in a specific style.

The mask refers to data used to suppress style transfer in a partial region of the image data. For example, the image data may be image data of 256×256×3 including 256 pixels in the vertical direction and 256 pixels in the horizontal direction and three color channels of RGB. The mask for the image data may be, for example, data having 256 pixels in the vertical direction and 256 pixels in the horizontal direction, and may be data of 256×256×1 in which a numerical value between 0 and 1 is given to each pixel. The mask may cause the style transfer to be suppressed stronger in the corresponding pixel of the image data as the value of the pixel becomes closer to 0. The mask may have a format different from the above description. For example, the mask may cause the style transfer to be suppressed stronger in the corresponding pixel of the image data as the value of the pixel becomes closer to 1. The maximum value of the pixel in the mask may be a value exceeding 1 or the like. The minimum value of the pixel in the mask may be a value less than 0. The value of the pixel in the mask may be only 0 or 1 (as a hard mask).

A mask acquisition source by the mask acquisition unit 104 may be a storage device to which the mask acquisition unit 104 is accessible. For example, the mask acquisition unit 104 may acquire the mask from the memory 12 or the storage device 13 provided in the server 10C. The mask acquisition unit 104 may acquire the mask from an external device via the communication network 30. Examples of the external device include the user terminal 20 and other servers, but are not limited thereto.

The mask acquisition unit 104 may generate a mask based on the image data. The mask acquisition unit 104 may generate a mask based on data acquired from the buffer or the like used for rendering. The buffer used for rendering includes, for example, a buffer used by a rendering engine having a function of rendering a three-dimensional CG image. The mask acquisition unit 104 may generate a mask based on other various types of data. The other various types of data include data of a mask different from the mask to be generated.

The style transfer unit 102C may use a neural network for the style transfer. For example, related technologies include Vincent Dumoulin, et. al. “A LEARNED REPRESENTATION FOR ARTISTIC STYLE”. An output image to which the style transfer is applied can be obtained by causing the style transfer unit 102C to input an input image of a predetermined size into the neural network.

The style transfer unit 102C inputs the image data acquired by the acquisition unit 101 and the mask acquired by the mask acquisition unit 104 to the neural network for the style transfer. This makes it possible to apply the style transfer based on one or more style images to the image data by using the mask.

An output destination of the data after application of the style transfer, by the output unit 103, may be a buffer different from the buffer from which the acquisition unit 101 acquires the image data. For example, in a case where the buffer from which the acquisition unit 101 acquires the image data is set to a first buffer, the output destination of the data after application of the style transfer may be set to a second buffer different from the first buffer. The second buffer may be a buffer used after the first buffer in a rendering process.

In addition, the output destination of the data after application of the style transfer, by the output unit 103, may be the storage device or the output device included in the server 10C or an external device seen from the server 10C.

As an aspect of the third embodiment, while suppressing style transfer in a partial region of the image data by using the mask, it is possible to perform the style transfer in other regions without suppression.

### Fourth Embodiment

An example of a style transfer program to be executed in a server that is an example of a computer will be described as a fourth embodiment. The server may be the server 10 included in the video game processing system 100 illustrated in FIG. 1.

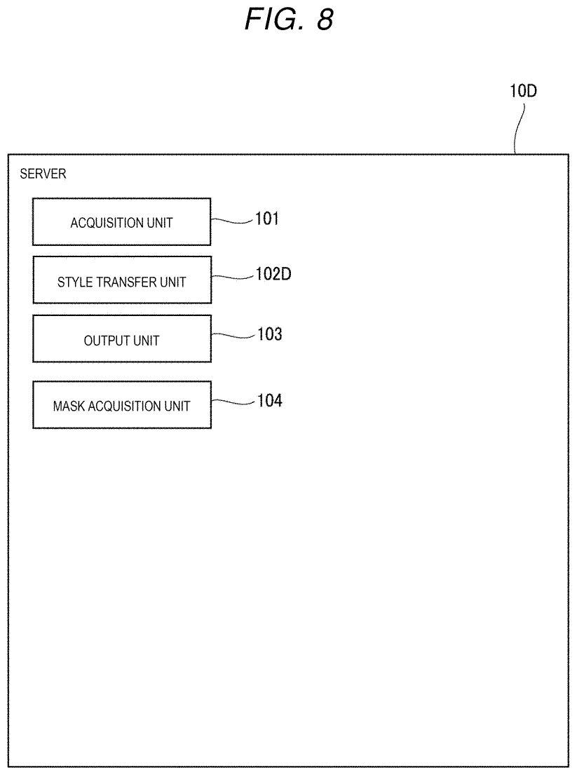

FIG. 8 is a block diagram of a configuration of a server 10D according to the fourth embodiment. The server 10D is an example of the server 10 and includes at least the acquisition unit 101, a style transfer unit 102D, the output unit 103, and the mask acquisition unit 104. A processor included in the server 10D functionally implements the acquisition unit 101, the style transfer unit 102D, the output unit 103, and the mask acquisition unit 104 by referring to a style transfer program stored in a storage device and executing the style transfer program.

The acquisition unit 101 has a function of acquiring image data. The style transfer unit 102D has a function of applying style transfer to the image data one or more times based on one or more style images. The style transfer unit 102D may repeatedly apply the style transfer to the image data a plurality of times based on one or more style images. The output unit 103 has a function of outputting data after the style transfer is applied. The mask acquisition unit 104 has a function of acquiring a mask for suppressing the style transfer in a partial region of the image data. The style transfer unit 102D has a function of applying style transfer to image data, based on a plurality of styles obtained from a plurality of style images, by using a plurality of masks for different regions in which the style transfer is suppressed.

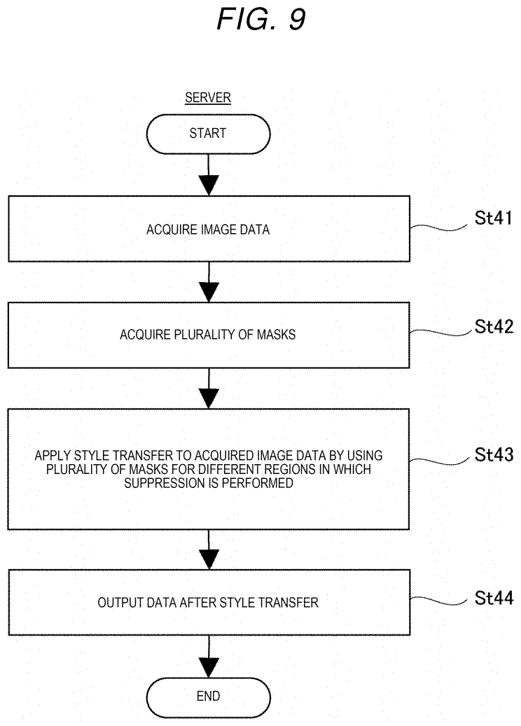

Next, program execution processing in the fourth embodiment will be described. FIG. 9 is a flowchart of processing of the style transfer program according to the fourth embodiment.

The acquisition unit 101 acquires image data (St41). The mask acquisition unit 104 acquires a plurality of masks for suppressing the style transfer in a partial region of the image data (St42). The plurality of acquired masks are provided for different regions in which the style transfer is suppressed. The style transfer unit 102D applies style transfer to image data by using a plurality of masks for different regions in which the style transfer is suppressed, based on a plurality of styles obtained from a plurality of style images (St43). The output unit 103 outputs the data after the style transfer is applied (St44).

The acquisition source of the image data by the acquisition unit 101 may be a storage device to which the acquisition unit 101 is accessible. For example, the acquisition unit 101 may acquire image data from the memory 12 or the storage device 13 provided in the server 10D. The acquisition unit 101 may acquire image data from an external device via a communication network 30. Examples of the external device include the user terminal 20 and other servers, but are not limited thereto.

The acquisition unit 101 may acquire the image data from a buffer used for rendering. The buffer used for rendering includes, for example, a buffer used by a rendering engine having a function of rendering a three-dimensional CG image.

A style includes, for example, a mode or a type in construction, art, music, or the like. For example, the style may include a painting style such as Gogh style or Picasso style. The style may include a format (for example, a color, a predetermined design, or a pattern) of an image. A style image includes an image (such as a still image or a moving image) drawn in a specific style.

The mask refers to data used to suppress style transfer in a partial region of the image data. For example, the image data may be image data of 256×256×3 including 256 pixels in the vertical direction and 256 pixels in the horizontal direction and three color channels of RGB. The mask for the image data may be, for example, data having 256 pixels in the vertical direction and 256 pixels in the horizontal direction, and may be data of 256×256×1 in which a numerical value between 0 and 1 is given to each pixel. The mask may cause the style transfer to be suppressed stronger in the corresponding pixel of the image data as the value of the pixel becomes closer to 0. The mask may have a format different from the above description. For example, the mask may cause the style transfer to be suppressed stronger in the corresponding pixel of the image data as the value of the pixel becomes closer to 1. The maximum value of the pixel in the mask may be a value exceeding 1 or the like. The minimum value of the pixel in the mask may be a value less than 0. The value of the pixel in the mask may be only 0 or 1 (as a hard mask).

A mask acquisition source by the mask acquisition unit 104 may be a storage device to which the mask acquisition unit 104 is accessible. For example, the mask acquisition unit 104 may acquire the mask from the memory 12 or the storage device 13 provided in the server 10D. The mask acquisition unit 104 may acquire the mask from an external device via the communication network 30. Examples of the external device include the user terminal 20 and other servers, but are not limited thereto.

The mask acquisition unit 104 may generate a mask based on the image data. The mask acquisition unit 104 may generate a mask based on data acquired from the buffer or the like used for rendering. The buffer used for rendering includes, for example, a buffer used by a rendering engine having a function of rendering a three-dimensional CG image. The mask acquisition unit 104 may generate a mask based on other various types of data. The other various types of data include data of a mask different from the mask to be generated.

The style transfer unit 102D may use a neural network for the style transfer. For example, related technologies include Vincent Dumoulin, et. al. “A LEARNED REPRESENTATION FOR ARTISTIC STYLE”. An output image to which the style transfer is applied can be obtained by causing the style transfer unit 102D to input an input image of a predetermined size into the neural network.

The style transfer unit 102D inputs the image data acquired by the acquisition unit 101 and the plurality of masks acquired by the mask acquisition unit 104 to the neural network for the style transfer. This makes it possible to apply the style transfer to the image data based on a plurality of style images by using a plurality of masks. A processing block in which another mask for a different region in which the style transfer is suppressed is generated based on the input mask may be provided in the neural network for the style transfer. The style transfer unit 102D may input one or more masks (masks other than the said another mask) acquired by the mask acquisition unit 104 to the neural network for the style transfer.

An output destination of the data after application of the style transfer, by the output unit 103, may be a buffer different from the buffer from which the acquisition unit 101 acquires the image data. For example, in a case where the buffer from which the acquisition unit 101 acquires the image data is set to a first buffer, the output destination of the data after application of the style transfer may be set to a second buffer different from the first buffer. The second buffer may be a buffer used after the first buffer in a rendering process.

In addition, the output destination of the data after application of the style transfer, by the output unit 103, may be the storage device or the output device included in the server 10D or an external device seen from the server 10D.

As an aspect of the fourth embodiment, by using a plurality of masks for different regions in which style transfer is suppressed, it is possible to apply a different style to the image data for each region of the image data.

As another aspect of the fourth embodiment, by appropriately adjusting the value in the mask, it is possible to blend style transfer based on a first style obtained from one or more style images with style transfer based on a second style obtained from one or more style images, for a region in image data.

### Fifth Embodiment

An example of a style transfer program to be executed in a server that is an example of a computer will be described as a fifth embodiment. The server may be the server 10 included in the video game processing system 100 illustrated in FIG. 1.

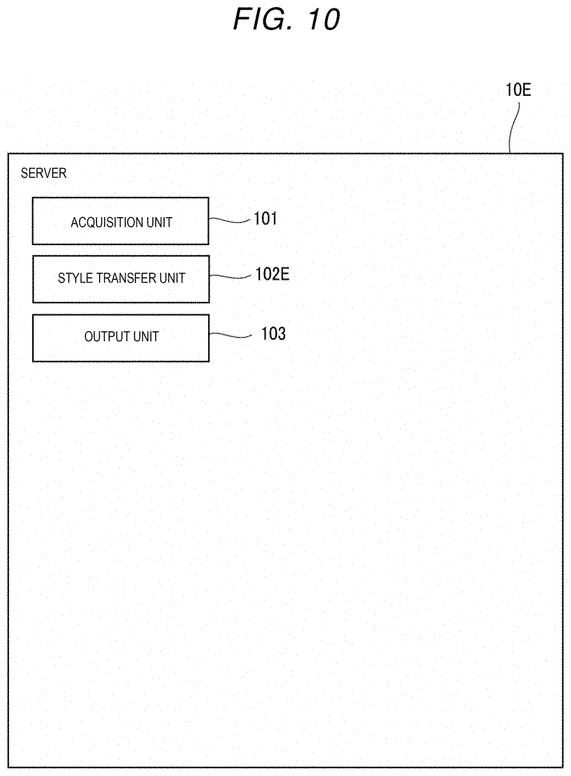

FIG. 10 is a block diagram of a configuration of a server 10E according to the fifth embodiment. The server 10E is an example of the server 10 and includes at least the acquisition unit 101, a style transfer unit 102E, and the output unit 103. A processor included in the server 10E functionally implements the acquisition unit 101, the style transfer unit 102E, and the output unit 103 by referring to a style transfer program stored in a storage device and executing the style transfer program.

The acquisition unit 101 has a function of acquiring image data. The style transfer unit 102E has a function of applying style transfer to the image data one or more times based on one or more style images. The style transfer unit 102E may repeatedly apply the style transfer to the image data a plurality of times based on one or more style images.

The style transfer unit 102E has a function of applying style transfer to the image data to output data formed by a color between a content color and a style color.

The content color is a color included in the image data. The style color is a color included in one or more style images to be applied to the image data.

The output unit 103 has a function of outputting data after the style transfer is applied.

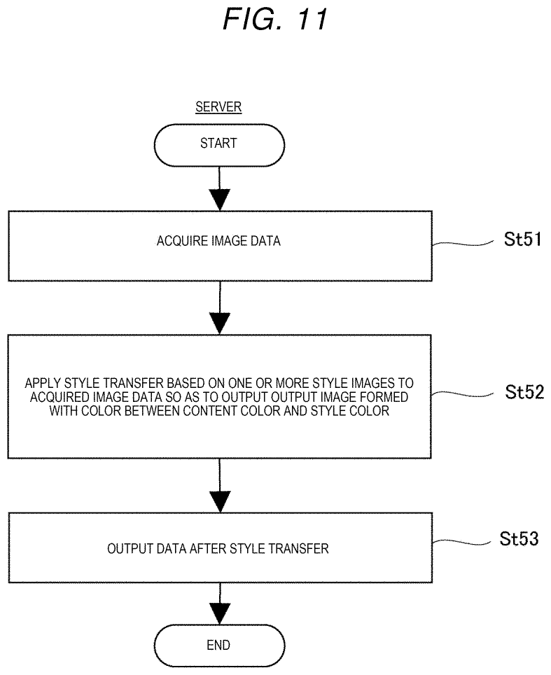

Next, program execution processing in the fifth embodiment will be described. FIG. 11 is a flowchart of processing of the style transfer program according to the fifth embodiment.

The acquisition unit 101 acquires image data (St51). The style transfer unit 102E applies the style transfer to the image data based on one or more style images (St52). In Step St52, the style transfer unit 102E applies the style transfer to the image data to output data formed by a color between a content color and a style color. The content color is a color included in the image data. The style color is a color included in one or more style images to be applied to the image data. The output unit 103 outputs the data after the style transfer is applied (St53).

The acquisition source of the image data by the acquisition unit 101 may be a storage device to which the acquisition unit 101 is accessible. For example, the acquisition unit 101 may acquire image data from the memory 12 or the storage device 13 provided in the server 10E. The acquisition unit 101 may acquire image data from an external device via the communication network 30. Examples of the external device include the user terminal 20 and other servers, but are not limited thereto.

The acquisition unit 101 may acquire the image data from a buffer used for rendering. The buffer used for rendering includes, for example, a buffer used by a rendering engine having a function of rendering a three-dimensional CG image.

A style includes, for example, a mode or a type in construction, art, music, or the like. For example, the style may include a painting style such as Gogh style or Picasso style. The style may include a format (for example, a color, a predetermined design, or a pattern) of an image. A style image includes an image (such as a still image or a moving image) drawn in a specific style.

The style transfer unit 102E may use a neural network for the style transfer. For example, related technologies include Vincent Dumoulin, et. al. “A LEARNED REPRESENTATION FOR ARTISTIC STYLE”. An output image to which the style transfer is applied can be obtained by causing the style transfer unit 102E to input an input image of a predetermined size into the neural network.

An output destination of the data after application of the style transfer, by the output unit 103, may be a buffer different from the buffer from which the acquisition unit 101 acquires the image data. For example, in a case where the buffer from which the acquisition unit 101 acquires the image data is set to a first buffer, the output destination of the data after application of the style transfer may be set to a second buffer different from the first buffer. The second buffer may be a buffer used after the first buffer in a rendering process.

In addition, the output destination of the data after application of the style transfer, by the output unit 103, may be the storage device or the output device included in the server 10E or an external device seen from the server 10E.

As an aspect of the fifth embodiment, it is possible to obtain an output image obtained by performing style transformation on the original image while a color between a content color being a color forming the original image (may also be referred to as a content image) and a style color being a color forming a style image is used as a color forming the output image.

### Sixth Embodiment

An example of a style transfer program to be executed in a server that is an example of a computer will be described as a sixth embodiment. The server may be the server 10 included in the video game processing system 100 illustrated in FIG. 1.

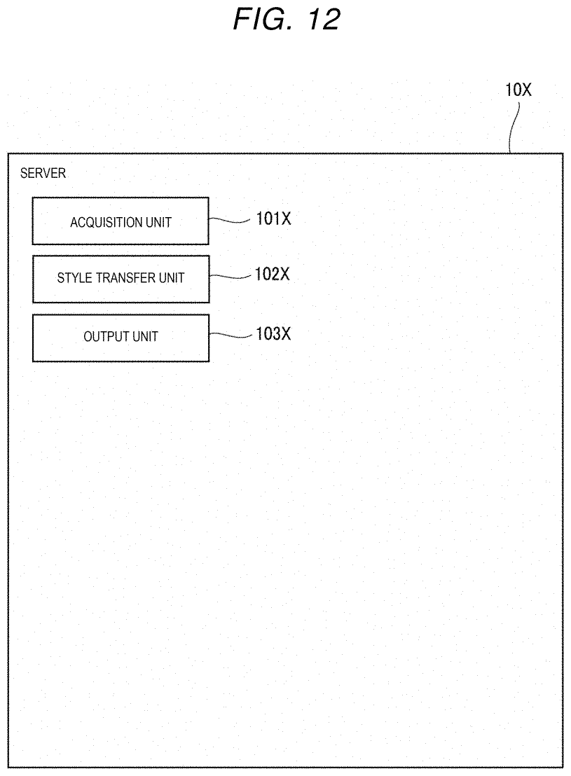

FIG. 12 is a block diagram of a configuration of a server 10X according to the sixth embodiment. The server 10X is an example of the server 10 and includes at least an acquisition unit 101X, a style transfer unit 102X, and an output unit 103X. A processor included in the server 10X functionally implements the acquisition unit 101X, the style transfer unit 102X, and the output unit 103X by referring to a style transfer program stored in a storage device and executing the style transfer program.

The acquisition unit 101X has a function of acquiring image data. The style transfer unit 102X has a function of applying style transfer to the image data one or more times based on one or more style images. The style transfer unit 102X may repeatedly apply the style transfer to the image data a plurality of times based on one or more style images. In this case, the style transfer unit 102X may repeatedly apply the style transfer to the image data based on one or more style images that are the same as those used for the style transfer already applied to the image data. The style transfer unit 102X may repeatedly apply the style transfer to the image data based on one or more style images including an image different from an image used for the style transfer already applied to the image data. The output unit 103X has a function of outputting data after the style transfer is applied.

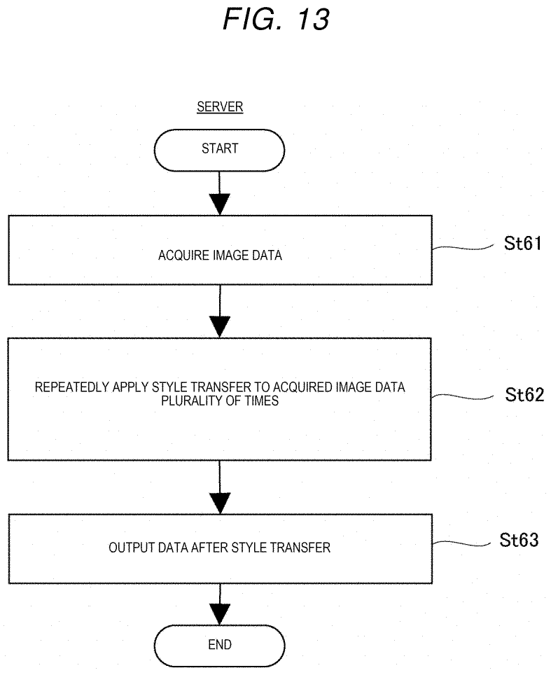

Next, program execution processing in the sixth embodiment will be described. FIG. 13 is a flowchart of processing of the style transfer program according to the sixth embodiment.

The acquisition unit 101X acquires image data (St61). The style transfer unit 102X repeatedly applies the style transfer to the image data a plurality of times based on one or more style images (St62). The output unit 103X outputs the data after the style transfer is applied (St63).

The acquisition source of the image data by the acquisition unit 101X may be a storage device to which the acquisition unit 101X is accessible. For example, the acquisition unit 101X may acquire image data from the memory 12 or the storage device 13 provided in the server 10X. The acquisition unit 101X may acquire image data from an external device via the communication network 30. Examples of the external device include the user terminal 20 and other servers, but are not limited thereto.

The acquisition unit 101X may acquire the image data from a buffer used for rendering. The buffer used for rendering includes, for example, a buffer used by a rendering engine having a function of rendering a three-dimensional CG image.

The buffer used for rendering may be a 3D buffer. The 3D buffer used for rendering includes, for example, a buffer that stores data capable of representing a three-dimensional space.

The buffer used for rendering may be an intermediate buffer. The intermediate buffer used for rendering is a buffer used in the middle of a rendering process. Examples of the intermediate buffer include but are not limited to an RGB buffer, a BaseColor buffer, a Metallic buffer, a Specular buffer, a Roughness buffer, and a Normal buffer. The buffers are buffers arranged before the final buffer in which a CG image finally output is stored, and are buffers different from the final buffer. The intermediate buffer used for rendering is not limited to the exemplified buffers described above.

A style includes, for example, a mode or a type in construction, art, music, or the like. For example, the style may include a painting style such as Gogh style or Picasso style. The style may include a format (for example, a color, a predetermined design, or a pattern) of an image. A style image includes an image (such as a still image or a moving image) drawn in a specific style.

An output destination of the data after application of the style transfer, by the output unit 103X, may be a buffer different from the buffer from which the acquisition unit 101X acquires the image data. For example, in a case where the buffer from which the acquisition unit 101X acquires the image data is set to a first buffer, the output destination of the data after application of the style transfer may be set to a second buffer different from the first buffer. The second buffer may be a buffer used after the first buffer in a rendering process.

In addition, the output destination of the data after application of the style transfer, by the output unit 103X, may be the storage device or the output device included in the server 10X or an external device seen from the server 10X.

Style Transfer Based on Single Style

The style transfer unit 102X may use a neural network for the style transfer. For example, related technologies include Vincent Dumoulin, et. al. “A LEARNED REPRESENTATION FOR ARTISTIC STYLE”. An output image to which the style transfer is applied can be obtained by causing the style transfer unit 102X to input an input image of a predetermined size into the neural network.

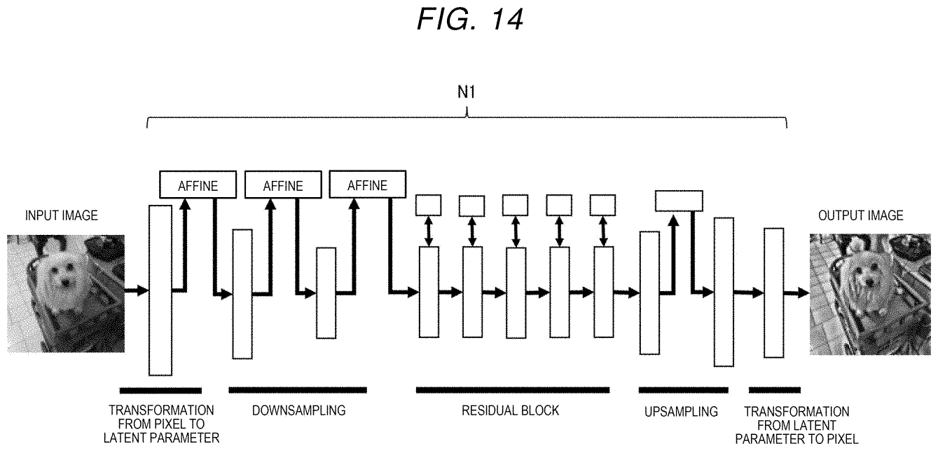

FIG. 14 is a conceptual diagram of a structure of a neural network N for style transfer according to at least one embodiment. The neural network N1 includes a first transformation layer for transforming a pixel group based on an input image into a latent parameter, one or more layers for performing downsampling by convolution or the like, a plurality of residual block layers, a layer for performing upsampling, and a second transformation layer for transforming a latent parameter into a pixel group. An output image can be obtained based on the pixel group that is an output of the second transformation layer.

In the neural network N1, a fully connected layer is arranged between the first transformation layer and the layer for performing the downsampling, between a plurality of convolutional layers included in the layer for performing the downsampling, and the like. The fully connected layer is referred to as an affine layer.

The style transfer unit 102X inputs the image data acquired by the acquisition unit 101X to the first transformation layer of the neural network N1. Accordingly, the data after application of the style transfer is output from the second transformation layer of the neural network N1.

Style Transfer in which Plurality of Style Images Are Blended

The style transfer unit 102X may perform style transfer in which a plurality of styles are blended for the same portion of the input image. In this case, the style transfer unit 102X mixes parameters based on a plurality of style images in a predetermined layer of the neural network, and inputs input image data to the trained neural network obtained by executing an optimization process based on an optimization function. The optimization function is suitable as long as the function is defined based on the plurality of style images.

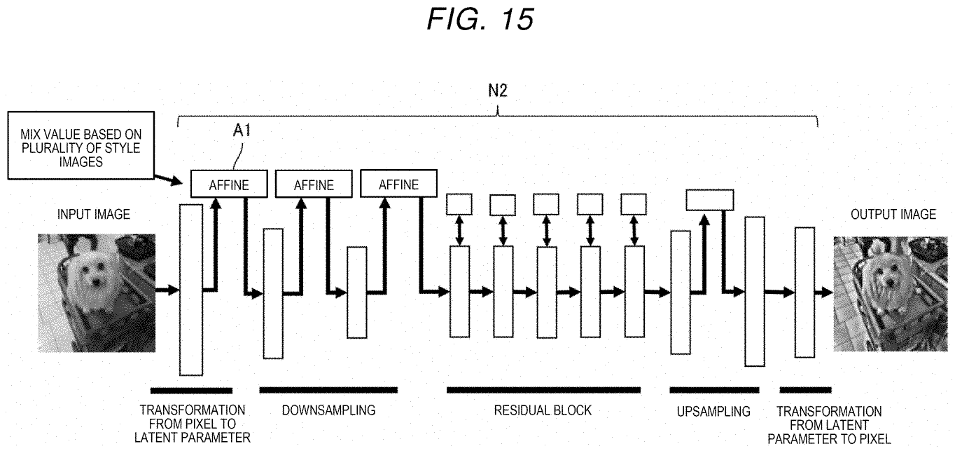

FIG. 15 is a conceptual diagram of a structure of a neural network N2 for the style transfer according to at least one embodiment. The neural network N2 includes a first transformation layer for transforming a pixel group based on an input image into a latent parameter, one or more layers for performing downsampling by convolution or the like, a plurality of residual block layers, a layer for performing upsampling, and a second transformation layer for transforming a latent parameter into a pixel group. An output image can be obtained based on the pixel group that is an output of the second transformation layer.

In the neural network N2, a fully connected layer is arranged between the first transformation layer and the layer for performing the downsampling, between a plurality of convolutional layers included in the layer for performing the downsampling, and the like. The fully connected layer is referred to as the affine layer.

Parameters based on the plurality of style images are mixed into an affine layer Al of the neural network N2. More specific descriptions are as follows.

In a case where parameters of affine transformation are denoted by a and b, and a latent variable of a pixel in an image is denoted by x, the affine layer A1 of the neural network N2 is a layer for executing a process of transforming a latent variable x of an output of a convolutional layer into x*a+b.

In a case where any Style 1 and Style 2 are blended, a process executed in the affine layer A1 under control of the style transfer unit 102X is as follows. Affine transformation parameters derived from a style image related to Style 1 are set as a₁ and b₁. Affine transformation parameters derived from a style image related to Style 2 are set as a₂ and b₂. Affine transformation parameters in a case of blending Style 1 and Style 2 are a=(a₁+a₂)/2 and b=(b₁+b₂)/2. Style 1 and Style 2 can be blended by calculating (x*a+b) in the affine layer A1. The above description shows a calculation expression in a case of equally (50% for each) blending Style 1 and Style 2. Based on the ordinary knowledge of those skilled in the art, blending may be performed after performing weighting in order to obtain a ratio of different degrees of influence based on each style such that Style 1 is 80% and Style 2 is 20%.

The number of styles to be blended may be greater than or equal to 3. In a case where n denotes a natural number greater than or equal to 3, for example, the affine transformation parameters in a case of blending n styles may be a=(a₁+a₂ . . . +aₙ)/n and b=(b₁+b2 . . . +bₙ)/n. In a case where k is any natural number between 1 and n, the affine transformation parameters derived from a style image related to Style k are set as aₖ and bₖ. The point that blending may be performed after performing weighting in order to obtain a ratio of different degrees of influence based on each style is similar to that in a case where the number of styles is 2.

The transformation parameters ak and bk for a plurality of styles may be stored in the memory 12 or the like of the server 10X. In addition, for example, the transformation parameters for the plurality of styles may be stored in the memory 12, the storage device 13, or the like in a vector format such as (a₁, a₂, . . . , aₙ) and (b₁, b₂, . . . , bₙ). In a case of performing weighting in order to obtain a ratio of different degrees of influence based on each style, a value indicating a weight corresponding to each style may be stored in the memory 12, the storage device 13, or the like.

Next, the optimization function for performing machine learning for the neural network N2 will be described. The optimization function is referred to as a loss function. The trained neural network N2 can be obtained by executing the optimization process on the neural network N2 based on the optimization function defined based on the plurality of style images. For convenience of description, the same reference sign N2 is used for each of the neural networks before and after training.

For example, in the related technology described above, an optimization function defined as follows is used.

Style Optimization Function:

$${s}_{} ( p ) = {\sum }_{i ∈ S} \frac{1}{{U}_{i}} {‖ G ( {ϕ}_{i} ( p ) ) - G ( {ϕ}_{i} ( s ) ) ‖}_{F}^{2}$$

Content Optimization Function:

$${c}_{} ( p ) = {\sum }_{j ∈ C} \frac{1}{{U}_{j}} {‖ {ϕ}_{j} ( p ) - {ϕ}_{j} ( c ) ‖}_{2}^{2}$$

In the optimization function, p denotes a generated image. The generated image corresponds to an output image of the neural network used for machine learning. For example, a style image such as an abstract painting is denoted by s (lower case s). The total number of units of a layer i is denoted by Ui. The total number of units of a layer j is denoted by Uⱼ. The Gram matrix is denoted by G. An output of an i-th activation function of a VGG-16 architecture is denoted by φᵢ. A layer group of VGG-16 for calculating optimization of the style is denoted by S (upper case S). A content image is denoted by c (lower case c). A layer group of VGG-16 for calculating the content optimization function is denoted by C (upper case C), and an index of a layer included in the layer group is denoted by j. The character F attached to absolute value symbols means the Frobenius norm.

An output image that is transformed to approximate the style indicated by the style image is output from the neural network by performing machine learning on the neural network for minimizing a value of the optimization function defined by the style optimization function and the content optimization function, and inputting the input image into the neural network after training.

In the optimization process using the optimization function described above, in a case of performing the style transfer by blending a plurality of styles, there is room for improvement in the result of blending.

Thus, the server 10X executes the optimization process based on the optimization function defined based on the plurality of style images. Accordingly, it is possible to perform optimization based on the plurality of style images. Consequently, it is possible to obtain an output image in which the plurality of styles are harmoniously blended with respect to an input image.

As one example, the optimization process may include a first optimization process of executing the optimization process by using a first optimization function defined based on any two style images selected from the plurality of style images and a second optimization process of executing the optimization process by using a second optimization function defined based on one style image among the plurality of style images. Accordingly, in a case where the number of styles desired to be blended is greater than or equal to 3, it is possible to perform suitable optimization. Consequently, it is possible to obtain an output image in which the plurality of styles are more harmoniously blended with respect to the input image.

Next, the first optimization function and the second optimization function will be described. As an aspect of the sixth embodiment, the first optimization function may be defined by Equation (1) below.

$${ℒ}_{q , r} ( p ) = {\sum }_{i ∈ S} {‖ \frac{G ( {ϕ}_{i} ( p ) )}{{N}_{i , r} * {N}_{i , c}} - \frac{1}{2} [ \frac{G ( {ϕ}_{i} ( q ) )}{{N}_{i , r} * {N}_{i , c}} + \frac{G ( {ϕ}_{i} ( r ) )}{{N}_{i , r} * {N}_{i , c}} ] ‖}_{F}^{2} ; q \neq r \qquad ( 1 )$$

$$∀ q ∀ r , q ∈ \hat{S} , r ∈ \hat{S}$$

As another aspect of the sixth embodiment, the second optimization function may be defined by Equation (2) below.

$${ℒ}_{s} ( p ) = {\sum }_{i ∈ S} {‖ \frac{G ( {ϕ}_{i} ( p ) )}{{N}_{i , r} * {N}_{i , c}} - \frac{G ( {ϕ}_{i} ( s ) )}{{N}_{i , r} * {N}_{i , c}} ‖}_{F}^{2} \qquad ( 2 )$$

In the above expression, is a style image group consisting of the plurality of style images, and q and r denote any style images included in the style image group. However, q and r are style images different from each other. The number of rows of a (φᵢ feature map is denoted by N_{i, r}. The number of columns of the φᵢ feature map is denoted by N_{i,c}. p, s (lower case s), G, φᵢ, S, c (lower case c), and F are the same as in the related technology described above.

When the generated image is denoted by p, and any two style images selected from a plurality of style images are denoted by q and r, the first optimization function is a function of adding norms between a value obtained by performing a predetermined calculation on the image p and an average value of values obtained by performing the predetermined calculation on the style images q and r. Equation (1) shows a case where

$$\frac{G ∘ {ϕ}_{i}}{{N}_{i , r} * {N}_{i , c}}$$

is the predetermined calculation. The predetermined calculation may be a calculation other than the above equation.

When the generated image is denoted by p, and the style image is denoted by s, the second optimization function is a function of adding norms between a value obtained by performing a predetermined calculation on the image p and a value obtained by performing the predetermined calculation on the style image s. Equation (2) illustrates a case where

$$\frac{G ∘ {ϕ}_{i}}{{N}_{i , r} * {N}_{i , c}}$$

is the predetermined calculation. The predetermined calculation may be a calculation other than the above equation.

Next, an example of the optimization process using the first optimization function and the second optimization function will be described.

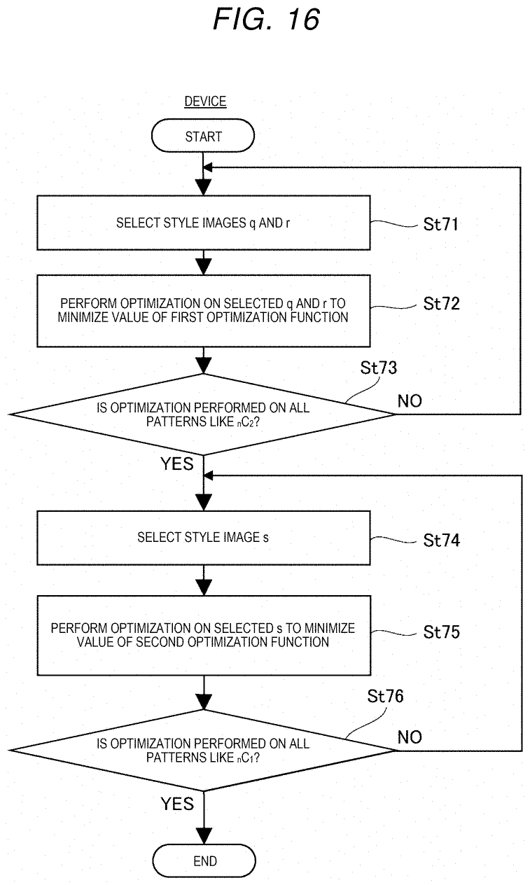

FIG. 16 is a flowchart of a process example of the optimization process according to at least one embodiment. The process example in a case where the first optimization function is the function defined by Equation (1), and the second optimization function is the function defined by Equation (2) will be described.

A process entity of the optimization process is a processor included in an apparatus. The apparatus (such as an apparatus A) including the processor may be the above-described server 10X. In this case, the processor 11 illustrated in FIG. 1 is the process entity. The apparatus A including the processor may be other apparatuses (for example, the user terminal 20 or another server) other than the server 10X.

The number of styles to be blended is denoted by n. The processor selects any two style images q and r from n style images included in the style image group (St71).

The processor performs optimization for minimizing a value of the first optimization function for the selected style images q and r (St72). For the generated image p, the processor acquires the output image of the neural network as the image p. The neural network may be implemented in the apparatus A or may be implemented in other apparatuses other than the apparatus A.

The processor determines whether or not optimization has been performed for all patterns of ₙC₂ (St73). The processor determines whether or not all patterns have been processed for selection of any two style images q and r from n style images. In a case where optimization has been performed for all patterns of ₙC₂ (St73: YES), the process transitions to Step St74. In a case where optimization has not been performed for all patterns of ₙC₂ (St73: NO), the process returns to Step St71, and the processor selects the subsequent combination of two style images q and r.

The processor selects one style image s from n style images included in the style image group (St74).

The processor performs optimization for minimizing a value of the second optimization function for the selected style image s (St75). For the generated image p, the processor acquires the output image of the neural network as the image p. The neural network may be implemented in the apparatus A or may be implemented in other apparatuses other than the apparatus A.

The processor determines whether or not optimization has been performed for all patterns of ₙC₁ (St76). The processor determines whether or not all patterns have been processed for selection of any style image s from n style images. In a case where optimization has been performed for all patterns of ₙC₁ (St76: YES), the optimization process illustrated in FIG. 16 is finished. In a case where optimization has not been performed for all patterns of ₙC₁ (St76: NO), the process returns to Step St74, and the processor selects the subsequent one style image s.

For example, the style transfer unit 102X inputs the image data acquired by the acquisition unit 101X into the first transformation layer of the trained neural network N2 optimized as described above. Accordingly, data after application of the style transfer in which n style images are harmoniously blended is output from the second transformation layer of the neural network N2.

For example, as described above, the style transfer unit 102X can apply the style transfer to image data based on the single style or the plurality of styles.

Repeatedly Applying Style Transfer

Referring again to FIG. 13, the style transfer unit 102X repeatedly applies the style transfer to the acquired image data a plurality of times based on one or more style images (FIG. 13, Step St62). Certain example processes of repeatedly applying the style transfer a plurality of times will be described below.

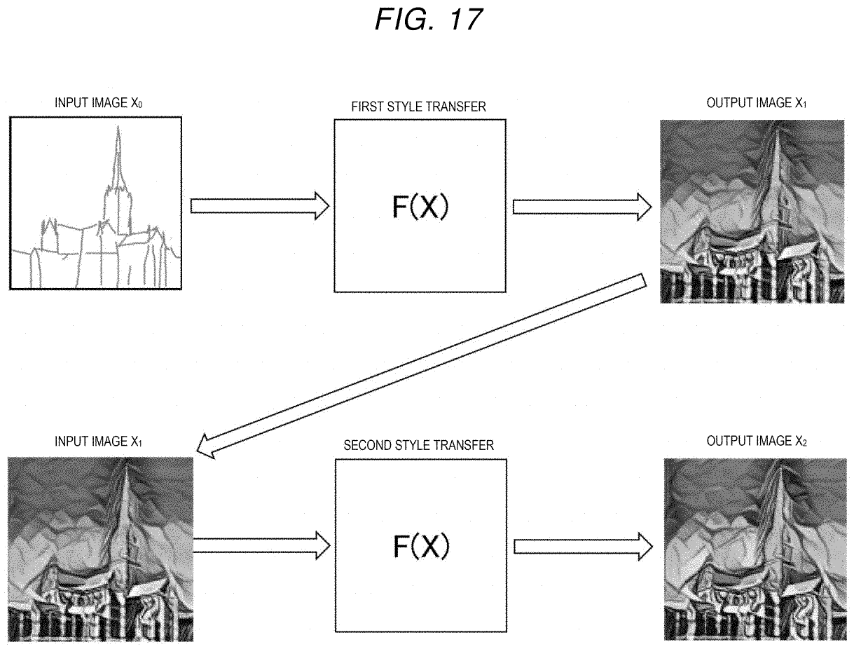

FIG. 17 is a conceptual diagram of an example process of repeatedly applying the style transfer a plurality of times according to at least one embodiment. The present example process of repeatedly applying the style transfer is performed based on the same one or more style images several times.

The neural network for style transfer may be, for example, the above-described neural network N1 or N2. Other neural networks may be used. The style transfer unit 102X inputs an input image X₀ acquired by the acquisition unit 101X to the neural network for style transfer. If the input image is input, an output image X₁ is output from the neural network. Since the output image X₁ is output when the input image X₀ is input, the neural network for the style transfer is represented as a function F(X) that transforms the input image X₀ into the output image X₁.

The style transfer unit 102X inputs the output image X₁ after the style transfer is applied once, as an input image, to the neural network for style transfer. As a result, an output image X₂ is output. The output image X₂ corresponds to an image obtained by repeatedly applying the style transfer twice to the input image X₀.

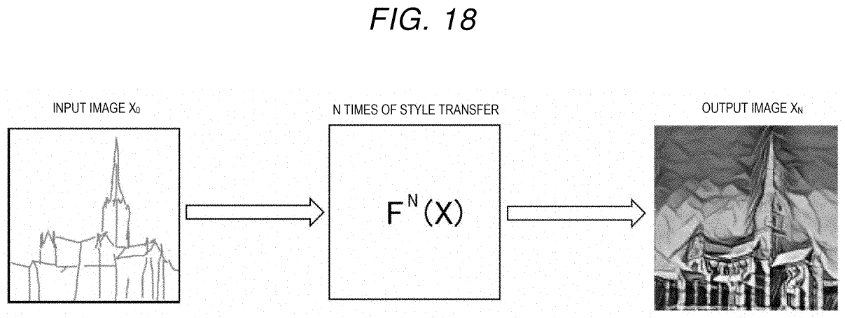

FIG. 18 is a conceptual diagram of an example process of repeatedly applying the style transfer a plurality of times according to at least one embodiment.

The style transfer unit 102X repeatedly applies the style transfer using the output image of the previous style transfer as an input image N times in the same manner as illustrated in FIG. 17. As a result, an output image X_{N} is output.

Comparing the output image X₁ after the style transfer is applied only once with the output image X_{N} after the style transfer based on the same one or more style images is repeatedly applied N times, the features of the applied style in the output image X_{N} are more emphasized. Further, the deformation of the line in the output image X_{N} based on the input image X₀ is larger than the deformation of the line in the output image X₁ based on the input image X₀.

As described above, since the style transfer unit 102X repeatedly applies the style transfer based on one or more style images that are the same as style images used in the style transfer applied already to the image data, it is possible to obtain an output image with more emphasized features of the style image and stronger deformation.

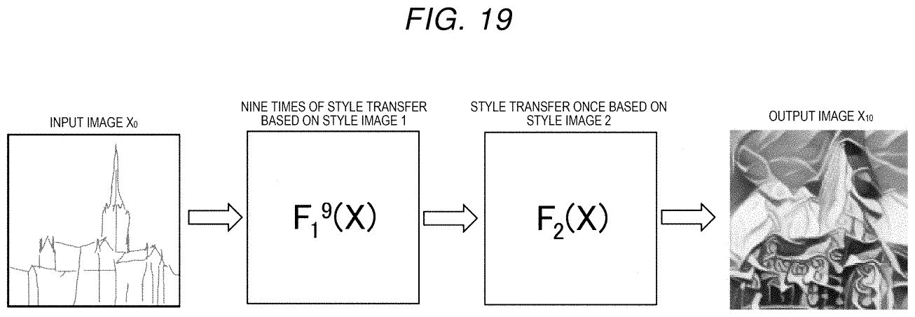

FIG. 19 is a conceptual diagram of an example process of repeatedly applying the style transfer a plurality of times according to at least one embodiment. The present example of repeatedly applying style transfer is performed based on one or more style images including at least one different image from the one or more images used for the style transfer already applied to the image data.

The application of style transfer once based on a style image A1 is represented by F₁(X). The application of style transfer once based on a style image A2 different from the style image A1 is represented by F₂(X).

For example, the style transfer unit 102X repeatedly applies the style transfer based on the style image A1 to the input image X₀ 9 times.

Then, the style transfer unit 102X applies the style transfer once based on the style image A2, by using output image data after the repetitive application of the style transfer 9 times as input image data. The style transfer unit 102X applies style transfer based on one or more style images including a style image A2 different from the image used for the style transfer applied already to the image data (style image A1). As a result, the output output image X₁₀ becomes an output image in which the influences of the style image A1 and the style image A2 are dynamically blended.

In the above description, the example of the process of repeatedly applying style transfers based on a single style image (style image A1 and style image A2) has been described. The style transfer unit 102X may repeatedly apply the style transfer in which the above-described plurality of style images are blended, a plurality of times.

The table below shows examples of patterns for repeatedly applying style transfer. In the examples, there are different style images A1 to A4. The numbers in the table indicate the style image numbers. Further, in the examples, repetitive application 10 times in maximum is performed.

TABLE 1

| First to fifth | Sixth to eighth | Ninth to tenth |
|---|---|---|
| A1 | A2 | |
| A1 | Blend of A2 and A3 | |
| Blend of A1 and A2 | A3 | |
| Blend of A1 and A2 | Blend of A2 and A3 | |
| Blend of A1 and A2 | Blend of A3 and A4 | |
| A1 | A2 | Blend of A3 and A4 |

The patterns shown in the above table are merely examples. The style transfer unit 102X may apply the style transfer based on other patterns for repetitive application. The number of times of the repetitive applications of the style transfer is not limited to 10.

As described above, the style transfer unit 102X repeatedly applies the style transfer to the image data based on one or more style images including an image different from an image used for the style transfer applied already to the image data. This makes it possible to dynamically style-apply a plurality of style images to the image data.

As an aspect of the sixth embodiment, since the style transfer based on the same one or more style images is repeatedly applied a plurality of times, it is possible to obtain an output image in which the features of the style are further emphasized and the deformation is stronger.

As another aspect of the sixth embodiment, it is possible to dynamically style-apply a plurality of style images to image data.

### Seventh Embodiment

An example of a style transfer program to be executed in a server will be described as a seventh embodiment. The server may be the server 10 included in the video game processing system 100 illustrated in FIG. 1.

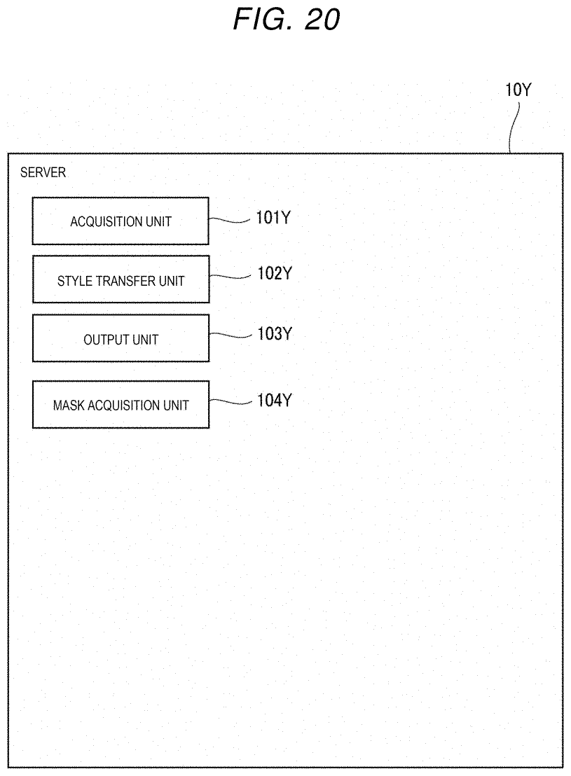

FIG. 20 is a block diagram of a configuration of a server 10Y according to the seventh embodiment. The server 10Y is an example of the server 10 and includes at least an acquisition unit 101Y, a style transfer unit 102Y, an output unit 103Y, and a mask acquisition unit 104Y. A processor included in the server 10Y functionally implements the acquisition unit 101Y, the style transfer unit 102Y, the output unit 103Y, and the mask acquisition unit 104Y by referring to a style transfer program stored in a storage device and executing the style transfer program.

The acquisition unit 101Y has a function of acquiring image data. The style transfer unit 102Y has a function of applying style transfer to the image data one or more times based on one or more style images. The style transfer unit 102Y may repeatedly apply the style transfer to the image data a plurality of times based on one or more style images. The output unit 103Y has a function of outputting data after the style transfer is applied. The mask acquisition unit 104Y has a function of acquiring a mask for suppressing the style transformation in a partial region of image data. The style transfer unit 102Y has a function of applying style transfer based on one or more style images to the image data by using the mask.

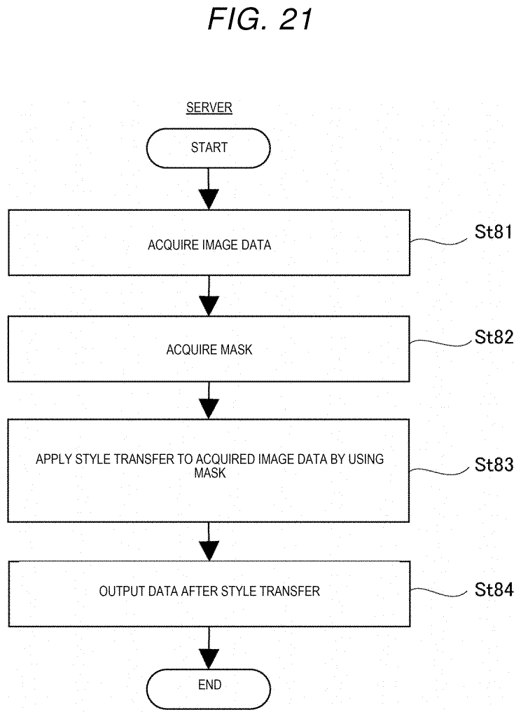

Next, program execution processing in the seventh embodiment will be described. FIG. 21 is a flowchart of processing of the style transfer program according to the seventh embodiment.

The acquisition unit 101Y acquires image data (St81). The mask acquisition unit 104Y acquires a mask for suppressing style transformation in a partial region of the image data (St82). The style transfer unit 102Y applies the style transfer to the image data by using the mask, based on one or more style images (St83). The output unit 103Y outputs the data after the style transfer is applied (St84).

In Step St82, the mask acquisition unit 104Y may acquire a plurality of masks for suppressing style transfer in a partial region of the image data. In this case, the plurality of acquired masks are provided for different regions in which the style transfer is suppressed. In Step St83, the style transfer unit 102Y applies style transfer to image data, based on a plurality of styles obtained from a plurality of style images, by using a plurality of masks for different regions in which the style transfer is suppressed.

The acquisition source of the image data by the acquisition unit 101Y may be a storage device to which the acquisition unit 101Y is accessible. For example, the acquisition unit 101Y may acquire image data from the memory 12 or the storage device 13 provided in the server 10Y. The acquisition unit 101Y may acquire image data from an external device via the communication network 30. Examples of the external device include the user terminal 20 and other servers, but are not limited thereto.

The acquisition unit 101Y may acquire the image data from a buffer used for rendering. The buffer used for rendering includes, for example, a buffer used by a rendering engine having a function of rendering a three-dimensional CG image.

A style includes, for example, a mode or a type in construction, art, music, or the like. For example, the style may include a painting style such as Gogh style or Picasso style. The style may include a format (for example, a color, a predetermined design, or a pattern) of an image. A style image includes an image (such as a still image or a moving image) drawn in a specific style.

The mask refers to data used to suppress style transfer in a partial region of the image data. For example, the image data may be image data of 256×256×3 including 256 pixels in the vertical direction and 256 pixels in the horizontal direction and three color channels of RGB. The mask for the image data may be, for example, data having 256 pixels in the vertical direction and 256 pixels in the horizontal direction, and may be data of 256×256×1 in which a numerical value between 0 and 1 is given to each pixel. The mask may cause the style transfer to be suppressed stronger in the corresponding pixel of the image data as the value of the pixel becomes closer to 0. The mask may have a format different from the above description. For example, the mask may cause the style transfer to be suppressed stronger in the corresponding pixel of the image data as the value of the pixel becomes closer to 1. The maximum value of the pixel in the mask may be a value exceeding 1 or the like. The minimum value of the pixel in the mask may be a value less than 0. The value of the pixel in the mask may be only 0 or 1 (as a hard mask).

A mask acquisition source by the mask acquisition unit 104Y may be a storage device to which the mask acquisition unit 104Y is accessible. For example, the mask acquisition unit 104Y may acquire the mask from the memory 12 or the storage device 13 provided in the server 10Y. The mask acquisition unit 104Y may acquire the mask from an external device via the communication network 30. Examples of the external device include the user terminal 20 and other servers, but are not limited thereto.

The mask acquisition unit 104Y may generate a mask based on the image data. The mask acquisition unit 104Y may generate a mask based on data acquired from the buffer or the like used for rendering. The buffer used for rendering includes, for example, a buffer used by a rendering engine having a function of rendering a three-dimensional CG image. The mask acquisition unit 104Y may generate a mask based on other various types of data. The other various types of data include data of a mask different from the mask to be generated.

The style transfer unit 102Y may use a neural network for the style transfer. For example, related technologies include Vincent Dumoulin, et. al. “A LEARNED REPRESENTATION FOR ARTISTIC STYLE”. An output image to which the style transfer is applied can be obtained by causing the style transfer unit 102Y to input an input image of a predetermined size into the neural network.

The style transfer unit 102Y inputs the image data acquired by the acquisition unit 101Y and the mask acquired by the mask acquisition unit 104Y to the neural network for the style transfer. This makes it possible to apply the style transfer based on one or more style images to the image data by using the mask.

The style transfer unit 102Y may input the image data acquired by the acquisition unit 101Y and the plurality of masks acquired by the mask acquisition unit 104Y to the neural network for the style transfer. This makes it possible to apply the style transfer based on a plurality of style images to the image data by using a plurality of masks. A processing block in which another mask for a different region in which the style transfer is suppressed is generated based on the input mask may be provided in the neural network for the style transfer. The style transfer unit 102Y may input one or more masks (masks other than the said another mask) acquired by the mask acquisition unit 104Y to the neural network for the style transfer.

An output destination of the data after application of the style transfer, by the output unit 103Y, may be a buffer different from the buffer from which the acquisition unit 101Y acquires the image data. For example, in a case where the buffer from which the acquisition unit 101Y acquires the image data is set to a first buffer, the output destination of the data after application of the style transfer may be set to a second buffer different from the first buffer. The second buffer may be a buffer used after the first buffer in a rendering process.

In addition, the output destination of the data after application of the style transfer, by the output unit 103Y, may be the storage device or the output device included in the server 10Y or an external device seen from the server 10Y.

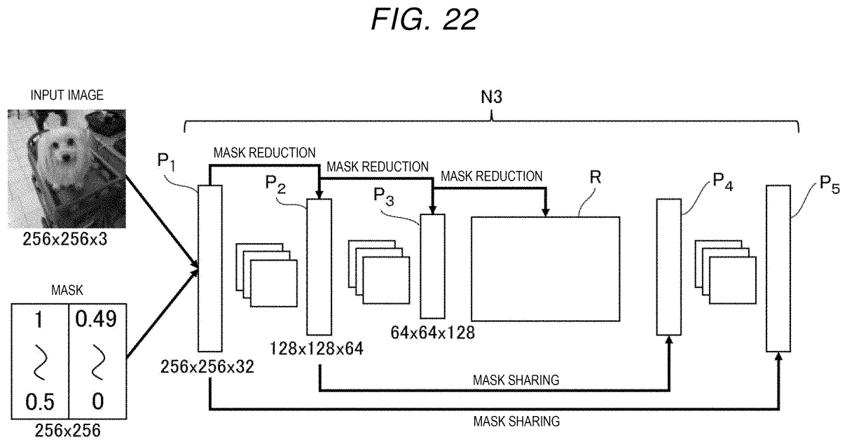

FIG. 22 is a conceptual diagram of a structure of a neural network N3 for a style transfer using a mask according to at least one embodiment.

The neural network N3 includes a plurality of processing layers P1 to P5. The neural network N3 further includes a residual block R.

The processing layer P1 corresponds to the first transformation layer in FIGS. 14 and 15. The processing layer P2 and the processing layer P3 correspond to one or more layers for performing downsampling in FIGS. 14 and 15. The residual block R corresponds to the residual block layers in FIGS. 14 and 15. The processing layer P4 and the processing layer P5 correspond to the layers for performing upsampling in FIGS. 14 and 15. The neural network N3 in FIG. 22 may further include the second transformation layer illustrated in FIGS. 14 and 15.

The processing layer P1 has a size of 256×256 x 32. The processing layer P2 has a size of 128×128×64. The processing layer P3 has a size of 64×64×128. The processing layer P4 has a size of 128×128×64. The processing layer P5 has a size of 256×256×32. The number of processing layers and the sizes of the processing layers are just examples.

The style transfer unit 102Y inputs the input image and the mask to the processing layer P₁. Each of the processing layers P₁ to P₅ includes a convolution process and a normalization process. The type of normalization process may be, for example, a conditional instance normalization.

Feature value data is/are extracted after the process by each processing layer. The extracted feature value data is/are input to the next processing layer. For example, the feature value data extracted from the processing layer P₁ is/are input to the processing layer P₂. The feature value data extracted from the processing layer P₂ is/are input to the processing layer P₃. The feature value data extracted from the processing layer P₄ is/are input to the processing layer P₅. For the processing layer P₃, results of the process by the processing layer P₃ are input to the residual block R. The output of the residual block R is input to the processing layer P₄.

The mask is input to each of the processing layers P₁ to P₅. Since the size of the processing layer varies depending on the processing layer, the size of the mask is also adapted in accordance with the processing layer.

For example, a mask obtained by reducing the mask input to the processing layer P₁ is input to the processing layer P₂. A mask obtained by reducing the mask input to the processing layer P₂ is input to the processing layer P₃. The reduction of the mask may be, for example, reduction based on the bilinear method.

In the present embodiment, since the size of the processing layer P₁ is equal to the size of the processing layer P₅, the mask input to the processing layer P₁ is input to the processing layer P₅. Similarly, since the size of the processing layer P₂ is equal to the size of the processing layer P₄, the mask input to the processing layer P₂ is input to the processing layer P₄.

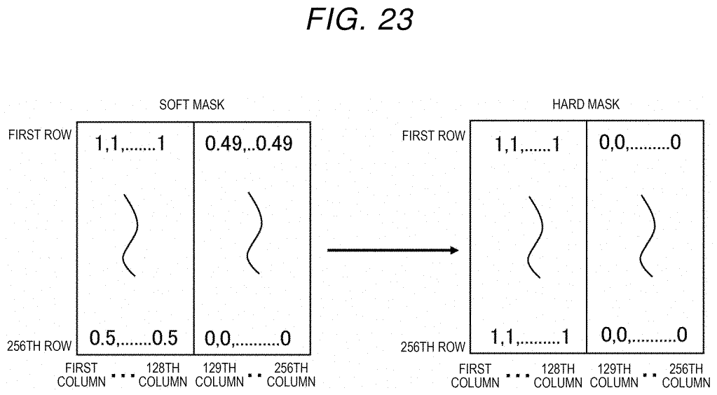

FIG. 23 is a conceptual diagram of the mask to be used in the style transfer according to at least one embodiment.

For example, the mask input to the processing layer P1 has a size of 256 in length×256 in width, which is similar to 256 in length×256 in width of the input image. The mask includes a soft mask and a hard mask. In the present embodiment, for example, the soft mask is input to the processing layer Pl. A case where the style transfer unit 102Y performs style transformation on the left half of an input image into Style A and performs style transformation on the right half of the input image into Style B will be described below as an example. Style A is a style corresponding to one or more style images. For example, Style A may correspond to one style image (Gogh style or the like), or may correspond to a plurality of style images (a blend of a Gogh style image and a Monet style image, and the like). Style B may correspond to one style image (Gauguin style or the like), or may correspond to a plurality of style images (a blend of a Gauguin style image and a Picasso style image, and the like). The case where the input image is divided into two portions of the left and the right and style transformation is performed is merely an example. Depending on how the value of the mask is set, it is possible to flexibly perform, for example, style transfer in a case where an input image is divided into two portions of the upper and the lower, style transfer in a case where an input image is divided into three or more portions, style transfer in which a mixture of a plurality of styles is applied in a certain region of an input image, and the like.

In a case where the style transfer unit 102Y performs style transformation on the left half of the input image into Style A and performs style transformation on the right half of the input image to Style B, the style transfer unit 102Y inputs a soft mask having different values in the left half and the right half to the processing layer Pl.

In the example illustrated in FIG. 23, in the first column to the 128th column, which correspond to the left half of the soft mask, the values in the first row are 1 and the values in the 256th row are 0.5. The second row to the 255th row in the first column to the 128th column have numerical values such that the values gradually decrease from 1 to 0.5.

In the example illustrated in FIG. 23, in the 129th column to the 256th column, which correspond to the right half of the soft mask, the values in the first row are 0.49 and the values in the 256th row are 0. The second row to the 255th row in the 129th column to the 256th column have numerical values such that the values gradually decrease from 0.49 to 0.

Next, an example of the hard mask will be described. The hard mask is a mask in which the numerical value in each row and each column is 0 or 1. For example, there is considered a hard mask in which the values are all 1 in the first column to the 128th column, which correspond to the left half of the hard mask, and the values are all 0 in the 129th column to the 256th column, which correspond to the right half. Such a hard mask can be generated by rounding off the numerical values in each row and each column in the above-described soft mask.

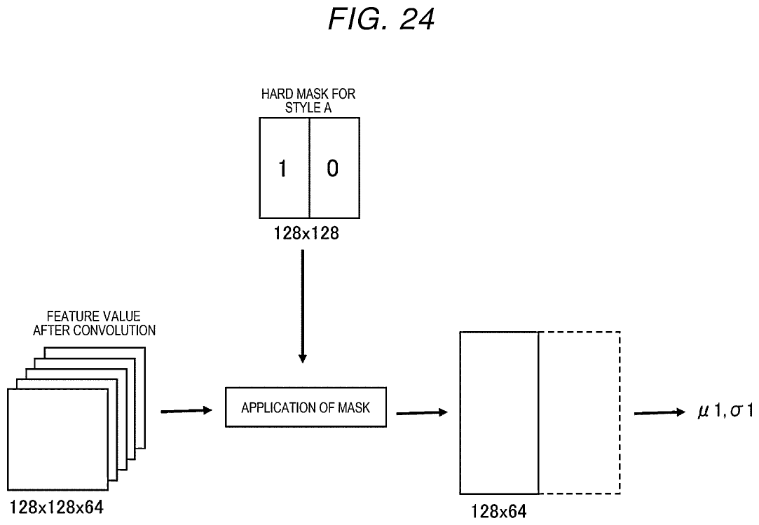

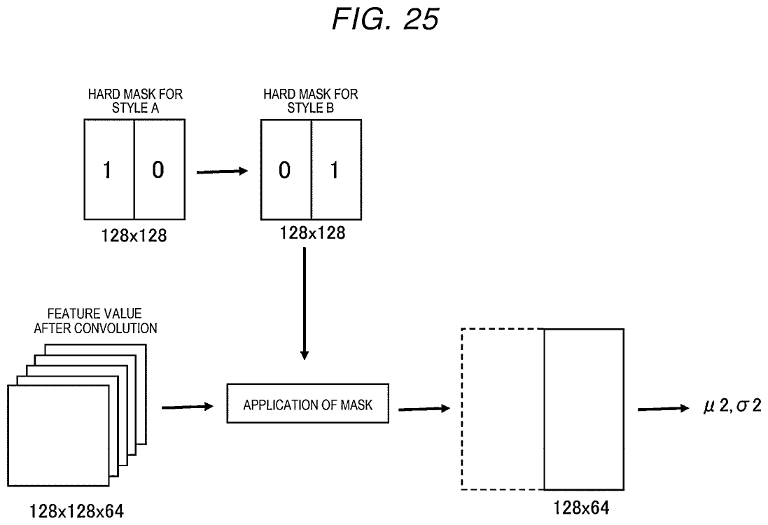

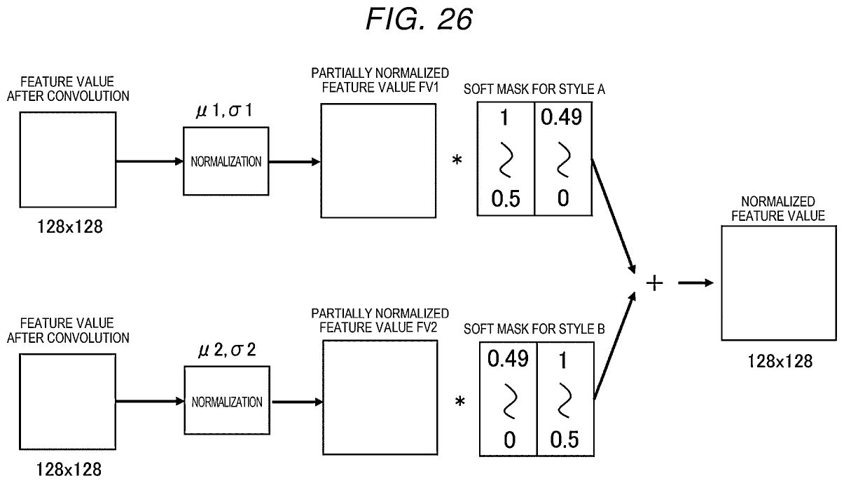

FIG. 24 is a conceptual diagram of a method of calculating the parameter for normalization to be performed in the processing layer according to at least one embodiment. FIG. 25 is a conceptual diagram of a method of calculating the parameter for normalization to be performed in the processing layer according to at least one embodiment. FIG. 26 is a conceptual diagram of normalization to be performed in the processing layer according to at least one embodiment. Certain examples of the normalization to be performed in the processing layer will be described with reference to FIGS. 24 to 26.

The size of the feature value data to be extracted varies depending on the processing layer (see FIG. 22). In addition, the size of the feature value data may change depending on the input image. Here, normalization will be described by exemplifying the feature value having a size of 128×128×64 after convolution.

The hard mask corresponding to Style A to be applied to the left half of the input image (may also be referred to as a hard mask for Style A) is a hard mask having 128 in length×128 in width, in which the values in the left half are all 1 and the values in the right half are all 0, as illustrated in FIG. 24. The hard mask for Style A can be generated by rounding off the numerical values in each row and each column in the soft mask illustrated in FIGS. 22 and 23 (may also be referred to as a soft mask for Style A).

The style transfer unit 102Y applies the above-described hard mask for Style A to the feature value data of 128 in length×128 in width after convolution. A method of applying the mask may be, for example, a Boolean mask. There is no intention to exclude mask application algorithms other than the Boolean mask.

If the style transfer unit 102Y applies the above-described hard mask for Style A to the feature value data (128×128) by the Boolean mask, data of 128 in length x 64 in width can be obtained. Only a portion corresponding to the portion (that is the left half in the example) having a value of 1 in the hard mask for Style A remains among the original feature values. The style transfer unit 102Y calculates the average p1 and the standard deviation o1 for the feature value data after application of the mask.

Then, the hard mask corresponding to Style B to be applied to the right half of the input image (may also be referred to as a hard mask for Style B) is a hard mask having 128 in length x 128 in width, in which the values in the left half are all 0 and the values in the right half are all 1, as illustrated in FIG. 25. The hard mask for Style B can be generated by inverting the values in the left half and the values in the right half in the above-described hard mask for Style A. The hard mask for Style B can be generated in a manner that a soft mask for Style B is generated by inverting the values in the left half and the values in the right half of the soft mask (that is the soft mask for Style A) illustrated in FIGS. 22 and 23, and then the numerical values of each row and each column in the soft mask for Style B are rounded off. Here, the soft mask for Style A and the soft mask for Style B correspond to a plurality of masks for different regions in which style transfer is suppressed. The hard mask for Style A and the hard mask for Style B also correspond to a plurality of masks for different regions in which style transfer is suppressed.

The style transfer unit 102Y applies the above-described hard mask for Style B to the feature value data of 128 in length×128 in width after convolution. A method of applying the mask may be, for example, a Boolean mask. There is no intention to exclude mask application algorithms other than the Boolean mask.

If the style transfer unit 102Y applies the above-described hard mask for Style B to the feature value data (128×128) by the Boolean mask, data of 128 in length×64 in width can be obtained. Only a portion corresponding to the portion (that is the right half in the example) having a value of 1 in the hard mask for Style B remains among the original feature values. The style transfer unit 102Y calculates the average p2 and the standard deviation o2 for the feature value data after application of the mask.

Next, description will be made with reference to FIG. 26. The style transfer unit 102Y normalizes the feature value data after convolution, by using the average p1 and the standard deviation 61. As a result, a partially normalized feature value FV1 can be obtained. The style transfer unit 102Y applies the soft mask for Style A to the partially normalized feature value FV1. The feature value obtained by applying this soft mask is referred to as a feature value FV1A. An algorithm for applying the soft mask for Style A to the feature value FV1 may be, for example, multiplying the values in the same row and the same column. For example, the result obtained by multiplying the value in the second row and the second column of the feature value FV1 and the value in the second row and the second column of the soft mask for Style A is the value in the second row and the second column of the feature value FV1A.

The style transfer unit 102Y normalizes the feature value data after convolution, by using the average p2 and the standard deviation o2. As a result, a partially normalized feature value FV2 can be obtained. The style transfer unit 102Y applies the soft mask for Style B to the partially normalized feature value FV2. The feature value obtained by applying this soft mask is referred to as a feature value FV2B. An algorithm for applying the soft mask for Style B to the feature value FV2 may be, for example, multiplying the values in the same row and the same column. For example, the result obtained by multiplying the value in the second row and the second column of the feature value FV2 and the value in the second row and the second column of the soft mask for Style B is the value in the second row and the second column of the feature value FV2B.

The style transfer unit 102Y adds the feature value FV1A and the feature value FV2B. As a result, a normalized feature value of 128 in length×128 in width can be obtained. The addition of the feature value FV1A and the feature value FV2B may correspond to, for example, addition of values in the same row and the same column. For example, the result obtained by adding the value in the second row and the second column of the feature value FV1A and the value in the second row and the second column of the feature value FV2B is the value in the second row and the second column of the normalized feature value.

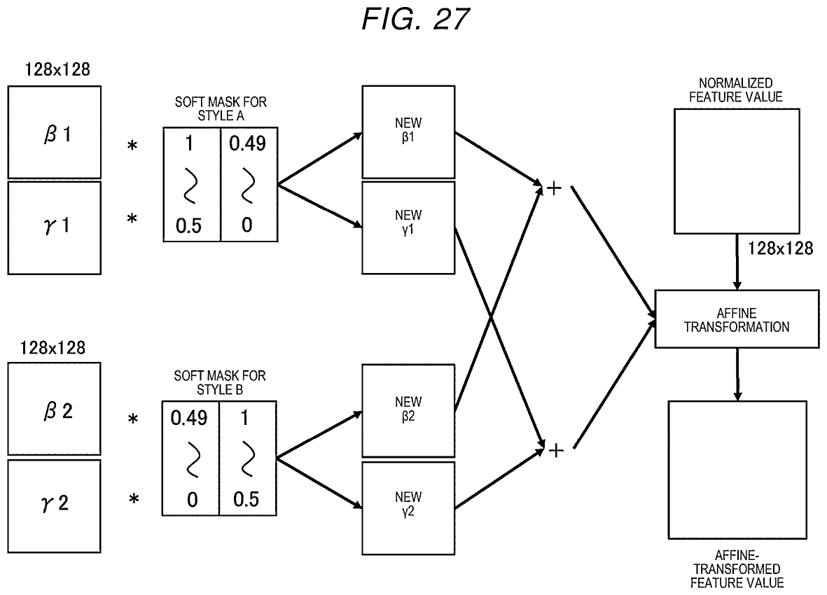

FIG. 27 is a conceptual diagram of an affine transformation process after the normalization according to at least one embodiment.

Two types of parameters used for the affine transformation for Style A are set as β1 and γ1, respectively. Two types of parameters used for the affine transformation for Style B are set as β2 and γ2, respectively. In this example, each of β1, β2, γ1, and γ2 is data having a size of 128×128.

The style transfer unit 102Y applies a soft mask for Style A to β1 and γ1. As a result, a new β1 and a new γ1 can be obtained. An algorithm for applying the soft mask for Style A may be, for example, multiplying the values in the same row and the same column. For example, the result obtained by multiplying the value in the second row and the second column of β1 and the value in the second row and the second column of the soft mask for Style A is the value in the second row and the second column of the new β1. The same applies to the application of the soft mask for Style A to γ1.

The style transfer unit 102Y applies a soft mask for Style B to β2 and γ2. As a result, a new β2 and a new γ2 can be obtained. An algorithm for applying the soft mask for Style B may be, for example, multiplying the values in the same row and the same column. For example, the result obtained by multiplying the value in the second row and the second column of β2 and the value in the second row and the second column of the soft mask for Style B is the value in the second row and the second column of the new β2. The same applies to the application of the soft mask for Style B to γ2.

The style transfer unit 102Y performs affine transformation on the normalized feature value (see FIG. 26) by using the data obtained by adding β1 and β2 and the data obtained by adding γ1 and γ2 as parameters (see FIGS. 14 and 15). As a result, the affine-transformed feature values are extracted from the processing layer.

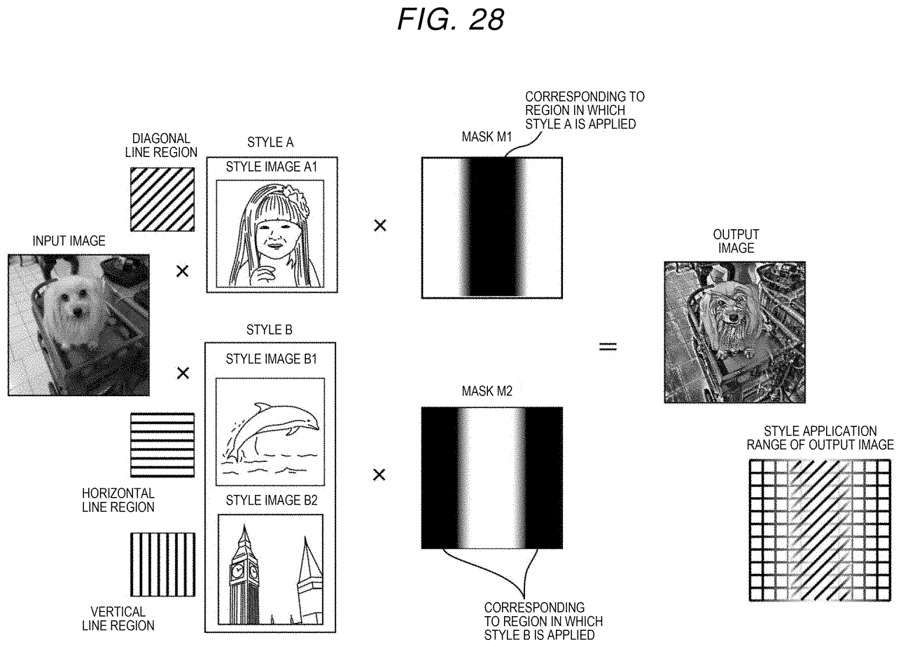

FIG. 28 is a conceptual diagram of a style transfer process using the mask according to at least one embodiment.

The acquisition unit 101Y acquires image data in which a dog is captured (Step St81). The mask acquisition unit 104Y acquires a mask M1 for suppressing style transfer in a partial region of the image data (Step St82). FIG. 28 illustrates the mask M1 for suppressing the style transformation in the left edge region and the right edge region in the image data. The central region (black) of the mask M1 has a value of 1 or close to 1. The left edge region (white) and the right edge region (white) of the mask M1 have a value of 0 or close to 0. Thus, for example, in a case where the mask M1 is transformed into a hard mask by rounding off, the value in the central region of the hard mask is 1, and the values in the left edge region and the right edge region are 0.

Further, the mask acquisition unit 104Y acquires a mask M2 in which the value of the mask M1 is inverted (Step St82). For example, when the value of a pixel at the coordinates (i, j) of the mask M1 is set as aᵢⱼ and the value of a pixel at the coordinates (i, j) of the mask M2 is set as bᵢⱼ, the mask acquisition unit 104Y may acquire the mask M2 in which the value of the mask M1 is inverted, by calculating bᵢⱼ=1−aiⱼ. When the mask M1 has a value of, for example, the soft mask for Style A illustrated in FIG. 26, the mask acquisition unit 104Y may acquire the mask M2 by replacing a left side region (1 to 0.5) and a right side region (0.49 to 0) with each other. The mask acquisition unit 104Y performs an inversion process (horizontal inversion, vertical inversion, 1−aᵢⱼ, and the like) in accordance with a form of the mask to be inverted. In addition, the value of each pixel of the mask M2 may be stored in the memory 12 or the storage device 13 in advance, and the mask acquisition unit 104Y may acquire the mask M2 from the memory 12 or the storage device 13. The central region (white) of the mask M2 has a value of 0 or close to 0. The left edge region (black) and the right edge region (black) of the mask M2 have a value of 1 or close to 1. Thus, for example, in a case where the mask M2 is transformed into a hard mask by rounding off, the value in the central region of the hard mask is 0, and the values in the left edge region and the right edge region are 1.

The style transfer unit 102Y applies the style transfer to the image data by using the mask, based on one or more style images (St83). In FIG. 28, the style transfer unit 102Y applies style transfer based on style images A1, B1, and B2 to the image data in which the dog is captured, by using the mask M1 and the mask M2. Style A is a style obtained from the style image A1 alone. Style B is a style obtained by blending the style image B1 and the style image B2. FIG. 28 conceptually illustrates the style transfer process using the mask. Therefore, the style images A1, B1, and B2 drawn in FIG. 28 are not the style images actually used by the applicant. For convenience of description, three rectangles indicating a diagonal line region, a horizontal line region, and a vertical line region are provided in the vicinity of each of the style images A1, B1, and B2. The three rectangles respectively indicating the diagonal line region, the horizontal line region, and the vertical line region are provided to illustrate where and to what extent each of the style images A1, B1, and B2 is applied in an output image. The mask M1 corresponds to the soft mask for Style A. The mask M2 corresponds to the soft mask for Style B.

The output unit 103Y outputs the data after the style transfer is applied (St84). In FIG. 28, the output unit 103Y outputs an output image in which the central region is style-transferred into Style A and each of the left edge region and the right edge region is style-transferred into Style B.

The values of the mask M1 and the mask M2 are continuous values between 0 and 1. Therefore, in a partial region of the output image (in the vicinity of a boundary between the central region and the edge region), Style A and Style B are not simply averaged but are mixed harmoniously by one calculation. In FIG. 28, a rectangle indicating a style application range of the output image is provided in the vicinity of the output image. In the vicinity of the boundary between the central region and the edge region of the output image, the diagonal line region (corresponding to the style image A1), the horizontal line region (corresponding to the style image B1), and the vertical line region (corresponding to the style image B2) are applied to be mixed. In a case where the hard mask is used as the mask M1 and the mask M2, Style A and Style B are not mixed in the output image, and the style transfer is performed with separating the style for each region.

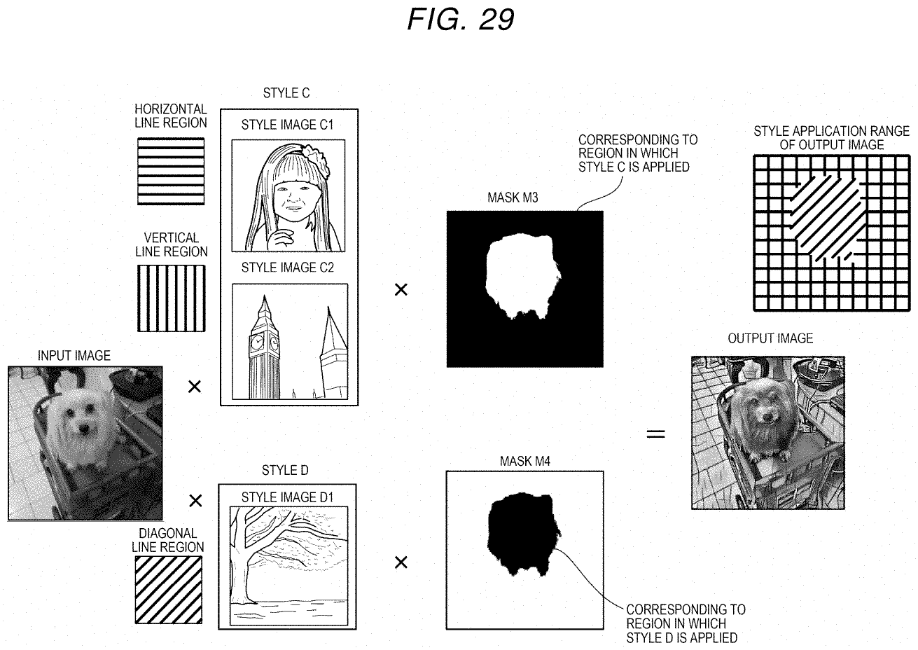

FIG. 29 is a conceptual diagram of a style transfer process using the mask according to at least one embodiment.

The acquisition unit 101Y acquires image data in which the dog is captured (St81). The mask acquisition unit 104Y acquires a mask M3 for suppressing style transfer in a partial region of the image data (St82). FIG. 29 illustrates the mask M3 for suppressing the style transfer in a region corresponding to the dog in the image data. The value of a region (black) in the mask M3, which corresponds to the portion other than the dog is 1. The value of the region (white) in the mask M3, which corresponds to the dog is 0.

Further, the mask acquisition unit 104Y acquires a mask M4 in which the value of the mask M3 is inverted (Step St82). For example, when the value of a pixel at the coordinates (i, j) of the mask M3 is set as c_{i,j} and the value of a pixel at the coordinates (i, j) of the mask M4 is set as dᵢⱼ, the mask acquisition unit 104Y may acquire the mask M4 in which the value of the mask M3 is inverted, by calculating dᵢⱼ=1−cᵢⱼ. When the mask M3 has a value of, for example, the hard mask for Style A illustrated in FIG. 25, the mask acquisition unit 104Y may acquire the mask M4 by replacing a left side region (value is 1) and a right side region (value is 0) with each other. The mask acquisition unit 104Y performs an inversion process (horizontal inversion, vertical inversion, 1−cᵢⱼ, and the like) in accordance with a form of the mask to be inverted. In addition, the value of each pixel of the mask M4 may be stored in the memory 12 or the storage device 13 in advance, and the mask acquisition unit 104Y may acquire the mask M4 from the memory 12 or the storage device 13. The value of a region (white) in the mask M4, which corresponds to a portion other than the dog, is 0. The value of a region (black) in the mask M4, which corresponds to the dog, is 1.

The style transfer unit 102Y applies the style transfer to the image data by using the mask, based on one or more style images (St83). In FIG. 29, the style transfer unit 102Y applies style transfer based on style images C1, C2, and D1 to the image data in which the dog is captured, by using the mask M3 and the mask M4. Style C is a style obtained by blending the style image C1 and the style image C2. Style D is a style obtained from the style image D1 alone. FIG. 29 conceptually illustrates the style transfer process using the mask. Therefore, the style images C1, C2, and D1 drawn in FIG. 29 are not the style images actually used by the applicant. For convenience of description, three rectangles indicating a horizontal line region, a vertical line region, and a diagonal line region are provided in the vicinity of each of the style images C1, C2, and Dl. The three rectangles respectively indicating the horizontal line region, the vertical line region, and the diagonal line region are provided to illustrate where and to what extent each of the style images C1, C2, and D1 is applied in an output image. The mask M3 corresponds to a hard mask for Style C. The mask M4 corresponds to a hard mask for Style D.

The output unit 103Y outputs the data after the style transfer is applied (St84). In FIG. 29, the output unit 103Y outputs an output image in which the region corresponding to the portion other than the dog is style-transferred into Style C and the region corresponding to the dog is style-transferred into Style D.

The values of the mask M3 and the mask M4 are 0 or 1. That is, the mask M3 and the mask M4 are hard masks. Therefore, in the output image, Style C and Style D are not mixed, and the style transfer is performed by one calculation with separating styles for the dog and the region other than the dog. In FIG. 29, a rectangle indicating a style application range of the output image is provided in the vicinity of the output image. A diagonal line region (corresponding to the style image D1) is applied in the region corresponding to the dog in the output image. In the region corresponding to the portion other than the dog in the output image, the horizontal line region (corresponding to the style image C1) and the vertical line region (corresponding to the style image C2) are applied.

Example of Utilizing Mask in case where Region is Divided into 3 or more Portions.

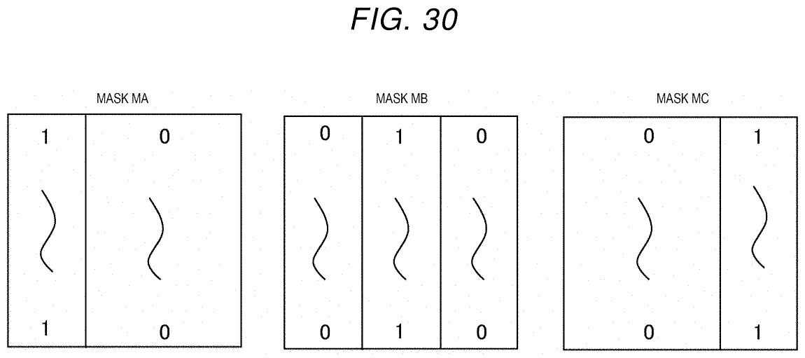

The mask can also be used in a case where a region in image data is to be divided into three or more portions and different styles are to be applied to the respective portions. FIG. 30 is a conceptual diagram of the mask for dividing image data into three regions and applying different styles to the respective regions according to at least one embodiment.

Three masks MA, MB, and MC are prepared. For example, in the mask MA, the left one-third region has a value of 1, and the other regions have a value of 0. In the mask MB, the central region has a value of 1, and the left one-third region and the right one-third region have a value of 0. In the mask MC, the right one-third region has a value of 1, and the other regions have a value of 0. The three divisions of the left side, the center, and the right side do not have to be strictly divided into three equal portions. In actual, 128 pixels and 256 pixels are not divisible by 3. As one example, the mask MA corresponds to Style A, the mask MB corresponds to Style B, and the mask MC corresponds to Style C. Further, Style A, Style B, and Style C are styles based on one or more different style images.

As described with reference to FIGS. 24 and 25, the style transfer unit 102Y applies the hard mask to the feature value data after convolution, and then calculates the average and the standard deviation. The average and the standard deviation corresponding to the mask MA are set as μ1 and σ1, respectively. The average and the standard deviation corresponding to the mask MB are set as μ2 and σ2, respectively. The average and the standard deviation corresponding to the mask MC are set as μ3 and σ3, respectively.

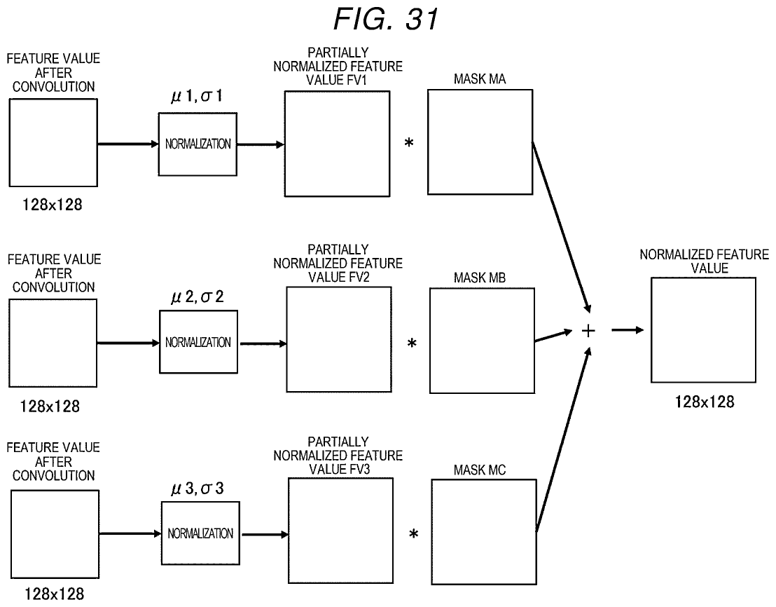

FIG. 31 is a conceptual diagram of the normalization to be performed in the processing layer according to at least one embodiment. As described with reference to FIG. 26, the style transfer unit 102Y normalizes the feature value data after convolution by using the average μ1 and the standard deviation σ1. As a result, a partially normalized feature value FV1 can be obtained. The style transfer unit 102Y applies the mask MA to the partially normalized feature value FV1. The feature value obtained by applying the mask MA is referred to as a feature value FV1A. An algorithm for applying the mask MA to the feature value FV1 may be, for example, multiplying the values in the same row and the same column. For example, the result obtained by multiplying the value in the second row and the second column of the feature value FV1 and the value in the second row and the second column of the mask MA is the value in the second row and the second column of the feature value FV1A.

The style transfer unit 102Y normalizes the feature value data after convolution, by using the average p2 and the standard deviation o2. As a result, a partially normalized feature value FV2 can be obtained. The style transfer unit 102Y applies the mask MB to the partially normalized feature value FV2. The feature value obtained by applying the mask MB is referred to as a feature value FV2B. An algorithm for applying the mask MB to the feature value FV2 may be, for example, multiplying the values in the same row and the same column. For example, the result obtained by multiplying the value in the second row and the second column of the feature value FV2 and the value in the second row and the second column of the mask MB is the value in the second row and the second column of the feature value FV2B.

The style transfer unit 102Y normalizes the feature value data after convolution, by using the average p3 and the standard deviation o3. As a result, a partially normalized feature value FV3 can be obtained. The style transfer unit 102Y applies the mask MC to the partially normalized feature value FV3. The feature value obtained by applying the mask MC is referred to as a feature value FV3C. An algorithm for applying the mask MC to the feature value FV3 may be, for example, multiplying the values in the same row and the same column. For example, the result obtained by multiplying the value in the second row and the second column of the feature value FV3 and the value in the second row and the second column of the mask MC is the value in the second row and the second column of the feature value FV3C.

The style transfer unit 102Y adds the feature value FV1A, the feature value FV2B, and the feature value FV3C. As a result, a normalized feature value of 128 in length x 128 in width can be obtained. The addition of the feature value FV1A, the feature value FV2B, and the feature value FV3C may correspond to, for example, addition of values in the same row and the same column. For example, the result obtained by adding the value in the second row and the second column of the feature value FV1A, the value in the second row and the second column of the feature value FV2B, and the value in the second row and the second column of the feature value FV3C is the value in the second row and the second column of the normalized feature value.

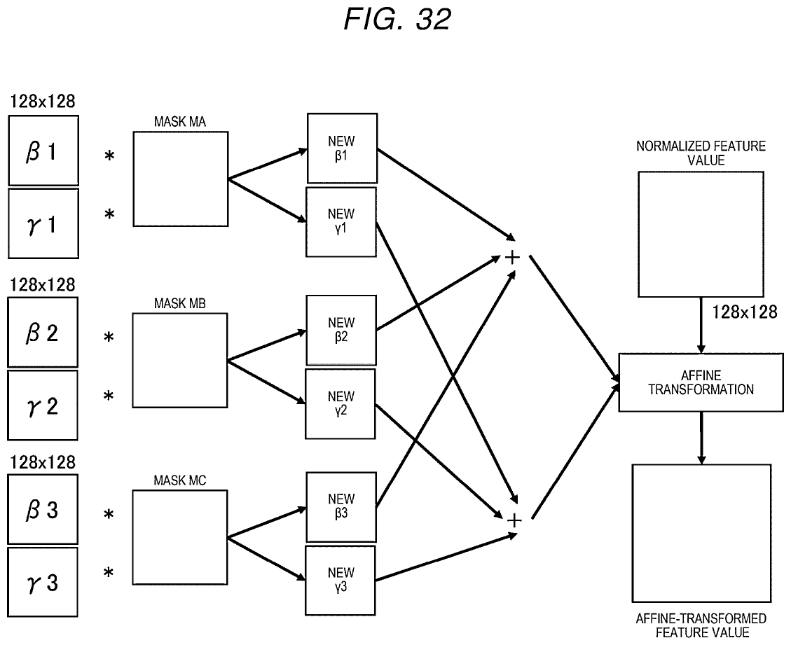

FIG. 32 is a conceptual diagram of the affine transformation process after the normalization according to at least one embodiment.

Two types of parameters used for the affine transformation for Style A are set as β1 and γ1, respectively. Two types of parameters used for the affine transformation for Style B are set as β2 and γ2, respectively. Two types of parameters used for the affine transformation for Style C are set as β31 and γ3, respectively. In this example, each of β1, β2, β3, γ1, γ2, and γ3 is data having a size of 128×128.

The style transfer unit 102Y applies the mask MA to β1 and γ1. As a result, a new β1 and a new γ1 can be obtained. The style transfer unit 102Y applies the mask MB to β2 and γ2. As a result, a new β2 and a new γ2 can be obtained. The style transfer unit 102Y applies the mask MC to β3 and γ3. As a result, a new β3 and a new γ3 are obtained. An algorithm for applying the mask MA, MB, or MC may be, for example, multiplying the values in the same row and the same column.

The style transfer unit 102Y performs affine transformation on the normalized feature value (see FIG. 31) by using the data obtained by adding β1, β2, and β3 and the data obtained by adding γ1, γ2, and γ3 as parameters (see FIGS. 14 and 15). As a result, the affine-transformed feature values are extracted from the processing layer.

For example, the style transfer unit 102Y inputs the input image and the masks MA, MB, and MC to the neural network N3. Thus, the output image in which the style transfer based on the styles different for the three regions of the left edge, the center, and the right edge is performed is output from the trained neural network.

Shape of Mask

Various shapes of the mask acquired by the mask acquisition unit 104Y can be considered. As described above, the masks are used to suppress style transfer in a partial region of image data. The partial region in the image data may be a corresponding region corresponding to one or more objects included in the image data, or may be a region other than the corresponding region. One or more objects may be some objects captured in an image. For example, the dog captured in the input images in FIGS. 28 and 29, a table on which the dog is placed, a combination of the dog and the table, and the like correspond to one or more objects. One or more objects may be a wall or a building captured in an image, or may be a design of a wall or a building or the like. One or more objects may be a portion of the object, for example, the lens portion of the glasses captured in the image, or the right arm of a character.

The object may be an in-game object. The in-game object includes, for example, a character, a weapon, a vehicle, a building, or the like that appears in a video game. The in-game objects may be mountains, forests, woods, trees, rivers, seas, and the like forming the map of the game. Further, the game is not limited to a video game, and includes, for example, an event-type game played using the real world, a game using an XR technology, and the like.

The partial region in the image data may be a corresponding region corresponding to one or more effects applied to the image data, or may be a region other than the corresponding region. The effect includes processing such as a blur effect and an emphasis effect applied to an image.

The effect may be an effect applied to the image data in the game. For example, there are a flame effect given to a sword captured in the image, the special move effect given to a character captured in the image, the effect on how the light hits the object captured in the image, and the like.

The partial region may be a corresponding region corresponding to a portion where the pixel value of the image data or buffer data of the buffer related to the generation of the image data satisfies a predetermined criterion, or may be a region other than the corresponding region. The portion where the pixel value satisfies the predetermined criterion includes, for example, a portion where the value of R is equal to or higher than a predetermined threshold value (has a reddish tint of a certain level or higher) in color image data having three channels of RGB. In this case, the mask may be generated in accordance with the pixel value of the image data. The portion where the buffer data of the buffer related to the generation of image data satisfies the predetermined criterion includes, for example, a portion where the value of each of the buffer data is equal to or higher than a predetermined threshold value. In this case, the mask may be generated in accordance with the value of each of the buffer data.

As an aspect of the seventh embodiment, while suppressing style transfer in a partial region of the image data by using the mask, it is possible to perform the style transfer in other regions without suppression.

As another aspect of the seventh embodiment, by using a plurality of masks for different regions in which style transfer is suppressed, it is possible to apply a different style to the image data for each region of the image data.

As still another aspect of the seventh embodiment, by appropriately adjusting the value in the mask, it is possible to blend style transfer based on a first style obtained from one or more style images with style transfer based on a second style obtained from one or more style images, for a certain region in image data.

As still another aspect of the seventh embodiment, it is possible to separate the style application form between one or more objects and the others.

As still another aspect of the seventh embodiment, it is possible to separate the style application form between one or more in-game objects and the others.

As still another aspect of the seventh embodiment, it is possible to separate the style application form between the region to which one or more effects are applied and the other regions.

As still another aspect of the seventh embodiment, it is possible to separate the style application form between the region to which one or more effects are applied and the other regions in a game.

As still another aspect of the seventh embodiment, it is possible to separate the style application form between the region corresponding to the portion where the pixel value of the image data or the buffer data of the buffer related to the generation of the image data satisfies a predetermined criterion and the other regions.

As still another aspect of the seventh embodiment, it is possible to perform style transfer by introducing an influence of the mask via the affine transformation used in the neural network.

### Eighth Embodiment

An example of a style transfer program executed in a server will be described as an eighth embodiment. The server may be the server 10 included in the video game processing system 100 illustrated in FIG. 1.

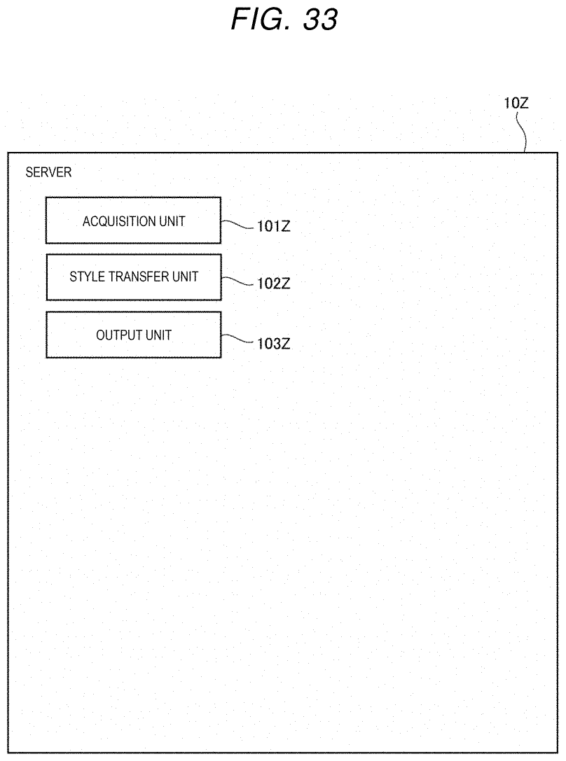

FIG. 33 is a block diagram of a configuration of a server 10Z according to the eighth embodiment. The server 10Z is an example of the server 10 and includes at least an acquisition unit 101Z, a style transfer unit 102Z, and an output unit 103Z. A processor included in the server 10Z functionally implements the acquisition unit 101Z, the style transfer unit 102Z, and the output unit 103Z by referring to a style transfer program stored in a storage device and executing the style transfer program.

The acquisition unit 101Z has a function of acquiring image data. The style transfer unit 102Z has a function of applying style transfer to the image data one or more times based on one or more style images. The style transfer unit 102Z may repeatedly apply the style transfer to the image data a plurality of times based on one or more style images.

The style transfer unit 102Z has a function of applying style transfer to the image data to output data formed by a color between a content color and a style color. The content color is a color forming the image data. The style color is a color forming one or more style images to be applied to the image data. The color forming the image data includes the color of a pixel included in the image data. The color forming the style image includes the color of a pixel included in the style image.

The output unit 103Z has a function of outputting data after the style transfer is applied.

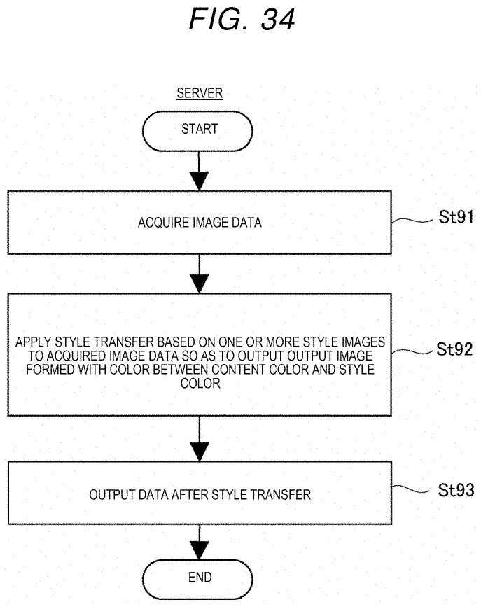

Next, program execution processing in the eighth embodiment will be described. FIG. 34 is a flowchart of processing of the style transfer program according to the eighth embodiment.

The acquisition unit 1012 acquires image data (St91). The style transfer unit 102Z applies the style transfer based on one or more style images to the image data (St92). In Step St92, the style transfer unit 102Z applies the style transfer to the image data to output data formed by a color between a content color and a style color. The content color is a color included in the image data. The style color is a color included in one or more style images to be applied to the image data. The output unit 103Z outputs the data after the style transfer is applied (St93).

The acquisition source of the image data by the acquisition unit 1012 may be a storage device to which the acquisition unit 1012 is accessible. For example, the acquisition unit 1012 may acquire image data from the memory 12 or the storage device 13 provided in the server 10Z. The acquisition unit 1012 may acquire image data from an external device via the communication network 30. Examples of the external device include the user terminal 20 and other servers, but are not limited thereto.

The acquisition unit 101Z may acquire the image data from a buffer used for rendering. The buffer used for rendering includes, for example, a buffer used by a rendering engine having a function of rendering a three-dimensional CG image.

A style includes, for example, a mode or a type in construction, art, music, or the like. For example, the style may include a painting style such as Gogh style or Picasso style. The style may include a format (for example, a color, a predetermined design, or a pattern) of an image. A style image includes an image (such as a still image or a moving image) drawn in a specific style.

The style transfer unit 102Z may use a neural network for the style transfer. For example, related technologies include Vincent Dumoulin, et. al. “A LEARNED REPRESENTATION FOR ARTISTIC STYLE”. The output image to which the style transfer is applied is obtained by causing the style transfer unit 102Z to input the input image of the predetermined size into the neural network.

An output destination of the data after application of the style transfer, by the output unit 103Z, may be a buffer different from the buffer from which the acquisition unit 1012 acquires the image data. For example, in a case where the buffer from which the acquisition unit 1012 acquires the image data is set to a first buffer, the output destination of the data after application of the style transfer may be set to a second buffer different from the first buffer. The second buffer may be a buffer used after the first buffer in a rendering process.

In addition, the output destination of the data after application of the style transfer, by the output unit 103Z, may be the storage device or the output device included in the server 10Z or an external device seen from the server 10Z.

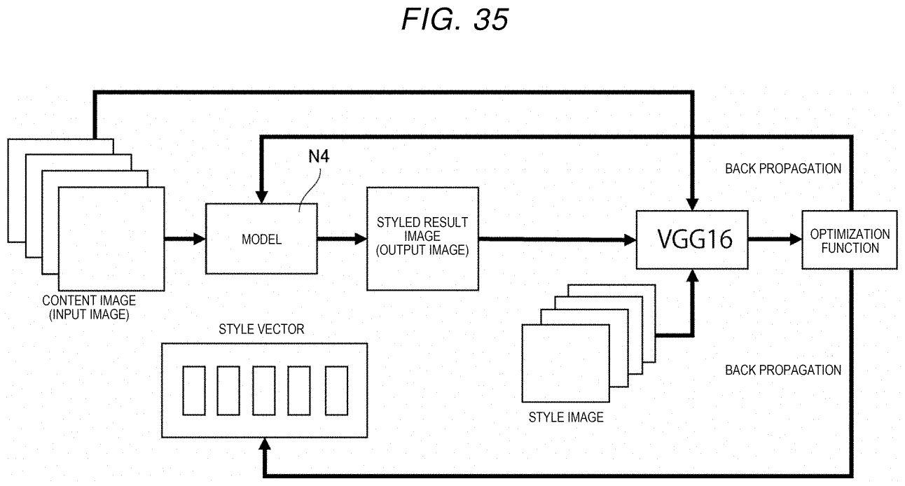

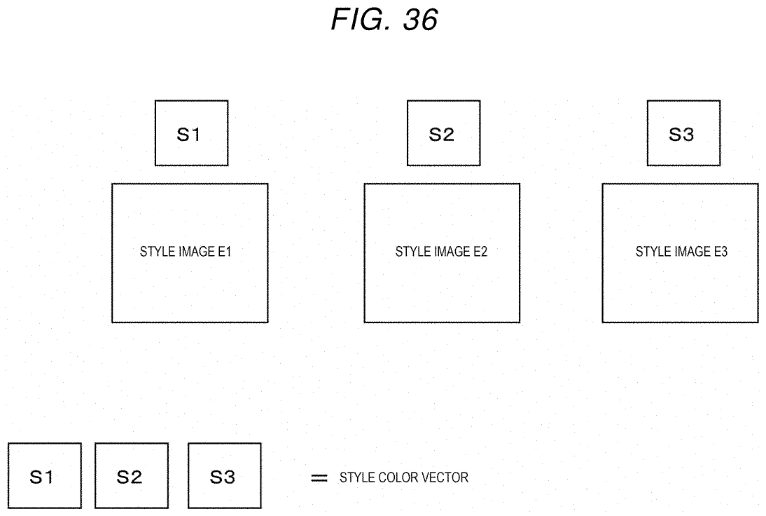

FIG. 35 is a conceptual diagram of a method of training a style transfer network according to at least one embodiment. FIG. 36 is a conceptual diagram of a configuration of a style vector according to at least one embodiment.

The training of the style transfer network is performed by a device including a processor. The device having a processor may be, for example, the server 10Z. The device having a processor may be a device other than the server 10Z. The processor in the device inputs a content image (that is an input image) to a neural network N4. The neural network N4 may be referred to as a style transfer network, a model, or the like. The neural network N4 corresponds to the neural networks N1, N2, and N3 in FIGS. 14, 15, and 22. When the processor inputs a content image (input image) to the neural network N4, a styled result image (that is an output image) is output.

A VGG 16 is disposed at the subsequent stage of the neural network N4. Since the VGG 16 is known, detailed description thereof will be omitted.

The processor inputs the content image, the style image, and the styled result image into the VGG 16. The processor calculates the optimization function (that is the loss function) at the subsequent stage of the VGG 16 and performs back propagation to the neural network N4 and the style vector. The style vector may be stored in, for example, the memory 12 or the storage device 13. By performing back propagation, training is performed on the neural network N4. As a result, the processor can perform style transfer by inputting the content image (that is the input image) to the neural network N4.

As illustrated in FIG. 36, one style vector used with the neural network N4 is defined for each style image. For example, a style vector S1 for a style image El, a style vector S2 for a style image E2, and a style vector S3 for a style image E3 are used. Each of the style vectors S1 to S3 is a vector of a style color defined based on color information included in the style image.

Style Transfer with Dynamic Color Control

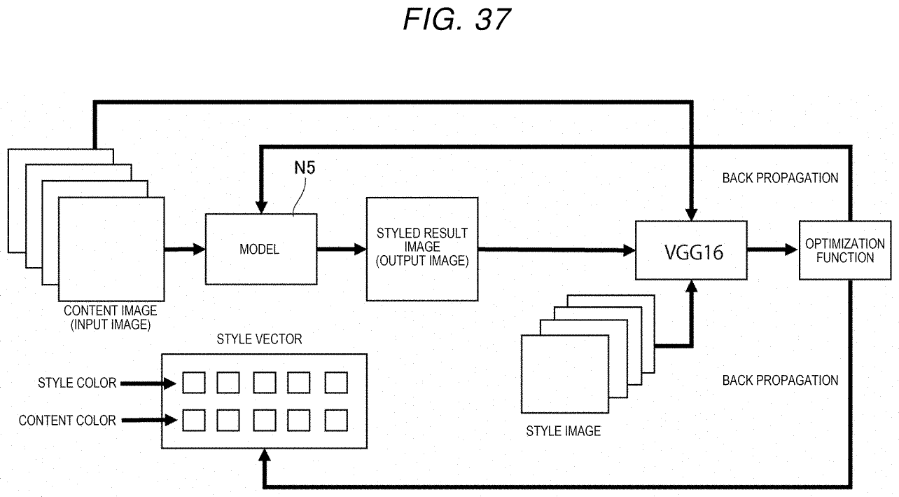

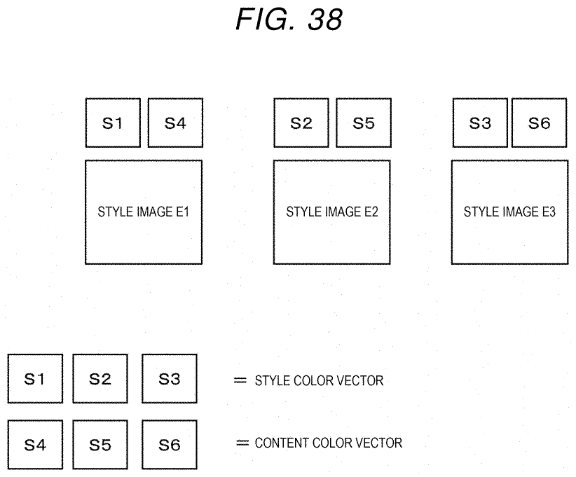

Next, the style transfer with dynamic color control will be described. FIG. 37 is a conceptual diagram of a method of training the style transfer network according to at least one embodiment. FIG. 38 is a conceptual diagram of a configuration of the style vector according to at least one embodiment.

The training of the style transfer network is performed by a device including a processor. The device having a processor may be, for example, the server 10Z. The device having a processor may be a device other than the server 10Z. The processor in the device inputs a content image (that is an input image) to a neural network N5. The neural network N5 may be referred to as a style transfer network, a model, or the like. The neural network N5 corresponds to the neural networks N1, N2, and N3 in FIGS. 14, 15, and 22. When the processor inputs a content image (input image) to the neural network N5, a styled result image (that is an output image) is output.

A VGG 16 is disposed at the subsequent stage of the neural network N5. Since the VGG 16 is known, detailed description thereof will be omitted.

The processor inputs the content image, the style image, and the styled result image into the VGG 16. The processor calculates the optimization function (that is the loss function) at the subsequent stage of the VGG 16 and performs back propagation to the neural network N5 and the style vector. The style vector may be stored in, for example, the memory 12 or the storage device 13. In this manner, training is performed on the neural network N5. As a result, the processor can perform style transfer by inputting the content image (that is the input image) to the neural network N5.

As illustrated in FIG. 38, two style vectors used with the neural network N5 are defined for each style image. For example, style vectors S1 and S4 for a style image El, style vectors S2 and S5 for a style image E2, and style vectors S3 and S6 for a style image E3 are used. On the other hand, each of the style vectors S1 to S3 is a vector of a style color defined based on color information included in the style image. In addition, each of the style vectors S4 to S6 is a vector of a content color defined based on color information included in the content image (input image).

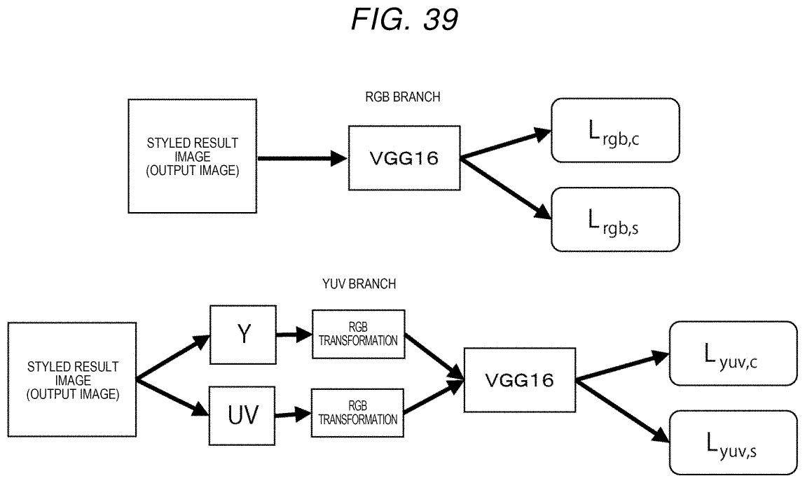

FIG. 39 is a conceptual diagram of part of the method of training the style transfer network according to at least one embodiment.

In at least one embodiment, the neural network N5 is trained in two types of color spaces which are a first color space and a second color space. The first color space is, for example, an RGB color space. The second color space is, for example, a YUV color space. Two types of optimization functions (loss functions) used for optimization by back propagation are used: RGB loss and YUV loss. Therefore, as illustrated in FIG. 39, there are two systems that are an RGB branch and a YUV branch, for calculating the optimization function. A color space other than the RGB color space or the YUV color space, for example, a YCbCr color space or a YPbPr color space may be used.

RGB Optimization

First, RGB optimization will be described. RGB optimization includes style optimization and content optimization. The style optimization function and the content optimization function are as follows.

Style Optimization Function:

$${ℒ}_{rgb , s} ( p ) = {\sum }_{i ∈ S} {‖ \frac{G ( {ϕ}_{i} ( {p}_{r ℊ b} ) )}{{N}_{i , r} * {N}_{i , c}} - \frac{G ( {ϕ}_{i} ( {s}_{r ℊ b} ) )}{{N}_{i , r} * {N}_{i , c}} ‖}_{F}^{2}$$

Content Optimization Function:

$${ℒ}_{rgb , c} ( p ) = {\sum }_{j ∈ C} \frac{1}{{U}_{j}} {‖ {ϕ}_{j} ( {p}_{r ℊ b} ) - {ϕ}_{j} ( {c}_{r ℊ b} ) ‖}_{2}^{2}$$

In the optimization function, p denotes a generated image. The generated image corresponds to an output image of the neural network used for machine learning. For example, a style image such as an abstract painting is denoted by s (lower case s). The total number of units of a layer j is denoted by Uⱼ. The Gram matrix is denoted by G. An output of an i-th activation function of a VGG-16 architecture is denoted by ϕᵢ. An output of a j-th activation function of the VGG-16 architecture is denoted by φⱼ. A layer group of VGG-16 for calculating optimization of the style is denoted by S (upper case S). A content image is denoted by c (lower case c). A layer group of VGG-16 for calculating the content optimization function is denoted by C (upper case C), and an index of a layer included in the layer group is denoted by j. The character F attached to absolute value symbols means the Frobenius norm. L, p, s, and c each having rgb as a subscript indicate the optimization function L for RGB, which is the first color space, the generated image p for RGB, the style image s for RGB, and the content image c for RGB, respectively. The number of rows of a φᵢ feature map is denoted by N_{i,r}. The number of columns of the φᵢ feature map is denoted by N_{i,c}.

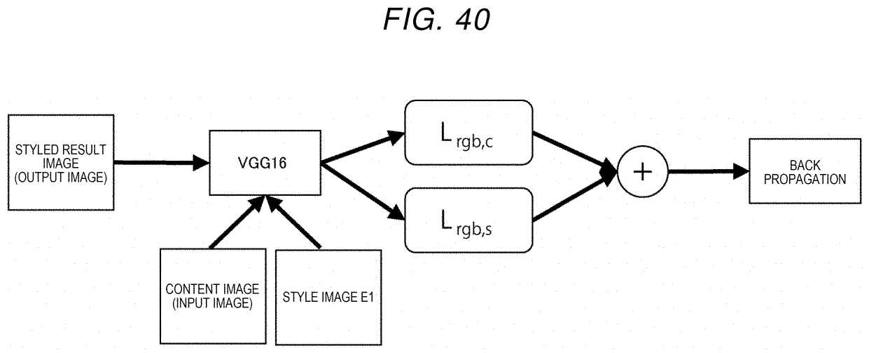

FIG. 40 is a conceptual diagram of an example of calculating the RGB optimization function in the RGB branch according to at least one embodiment. A styled result image in FIG. 40 corresponds to p_{rgb}. A content image (that is an input image) in FIG. 40 corresponds to c_{rgb}. A style image E1 in FIG. 40 corresponds to s_{rgb}. The processor adds the value of the style optimization function L_{rgb,s} and the value of the content optimization function L_{rgb,c}, and performs back propagation to minimize the value of the result of the addition.

YUV Optimization

Next, YUV optimization will be described. YUV optimization includes style optimization and content optimization. The style optimization function and the content optimization function are as follows.

Style Optimization Function:

$${ℒ}_{yuv , s} ( p ) = {\sum }_{i ∈ S} {‖ \frac{G ( {ϕ}_{i} ( {p}_{y} ) )}{{N}_{i , r} * {N}_{i , c}} - \frac{G ( {ϕ}_{i} ( {s}_{y} ) )}{{N}_{i , r} * {N}_{i , c}} ‖}_{F}^{2}$$

Content Optimization Function:

$${ℒ}_{yuv , c} ( p ) = {ℒ}_{y , c} ( p ) + {ℒ}_{uv , c} ( p )$$

$${ℒ}_{y , c} ( p ) = {\sum }_{j ∈ C} \frac{1}{{U}_{j}} {‖ {ϕ}_{j} ( {p}_{y} ) - {ϕ}_{j} ( {c}_{y} ) ‖}_{2}^{2}$$

$${ℒ}_{uv , c} ( p ) = {\sum }_{j ∈ C} \frac{1}{{U}_{j}} {‖ {ϕ}_{j} ( {p}_{uv} ) - {ϕ}_{j} ( {c}_{uv} ) ‖}_{2}^{2}$$

p, s (lower case s), Uⱼ, G, φᵢ, φⱼ, S (upper case S), c, C, F, N_{i, r}, and Ni, _{c} have the meanings similar to the above description of the RGB optimization. L, p, s, and c each having y as a subscript indicate the optimization function L for a Y channel in YUV that is the second color space, the generated image p for the Y channel, the style image s for the Y channel, and the content image c for the Y channel, respectively. L, p, and c each having uv as a subscript indicate the optimization function L for a UV channel in YUV that is the second color space, the generated image p for the UV channel, and the content image c for the UV channel, respectively.

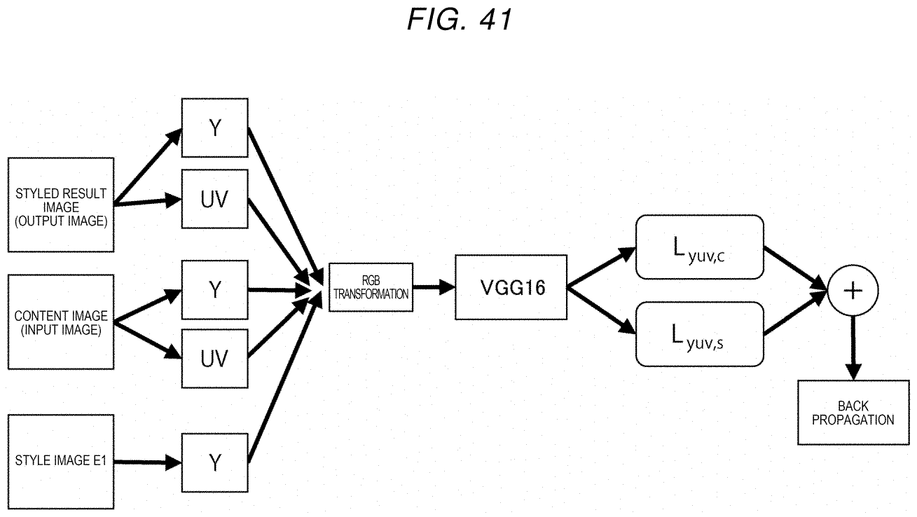

FIG. 41 is a conceptual diagram of an example of calculating the YUV optimization function in the YUV branch according to at least one embodiment. The processor YUV-transforms the styled result image (the output image), the content image (the input image), and the style image. Then, the processor extracts the Y channel and the UV channel from the data after transformation, and performs transformation again into RGB. The reason for transformation again into RGB is that the subsequent VGG 16 is configured to recognize RGB.

The resultants obtained by YUV-transforming the styled result image (the output image) in FIG. 41 to extract the Y channel and the UV channel, and performing RGB transformation again correspond to p_{y} and pᵤᵥ, respectively. The resultants obtained by YUV-transforming the content image (the input image) in FIG. 41 to extract the Y channel and the UV channel, and performing RGB transformation again correspond to c_{y} and cᵤᵥ, respectively. The resultant obtained by YUV-transforming the style image in FIG. 41 to extract the Y channel, and performing RGB transformation again corresponds to s_{y}. The processor adds the value of the style optimization function L_{yuv,s} and the value of the content optimization function L_{yuv,c}, and performs back propagation to minimize the value of the result of the addition.

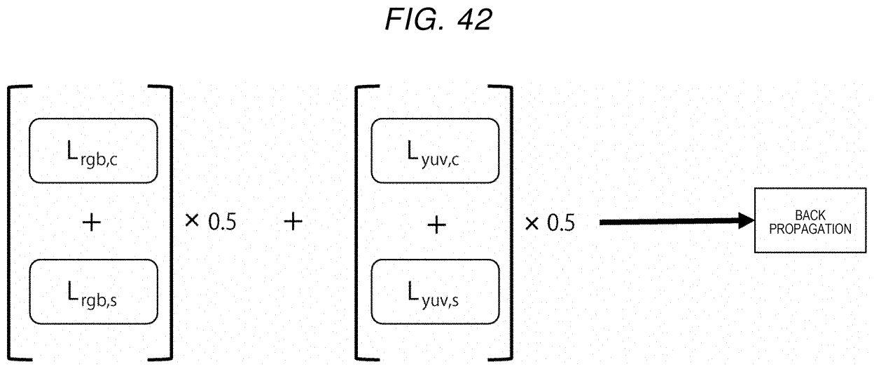

FIG. 42 is a conceptual diagram of the optimization function in the style transfer that dynamically controls colors according to at least one embodiment. The processor further calculates the following optimization function L.

L=( [symbol] _{rgb,s}(p)+ [symbol] _{rgb,s}(p))*0.5+( [symbol] _{yuv,s}(p)+ [symbol] _{yuv,c}(p))*0.5

The processor performs back propagation to minimize the value of the optimization function L.

As described above, the processor performs the optimization using optimization functions of two systems of the RGB branch and the YUV branch. The Optimization based on back propagation is performed on the RGB branch, the YUV branch, and a branch obtained by combining the RGB branch and the YUV branch. Thus, training of the neural network N5 based on one style image proceeds. The processor inputs the content image (the input image) to the trained neural network N5, and thus data (that is/are the desired image data) obtained by applying the style transfer to the content image is output.

Style Transfer with Dynamic Color Control based on Two or more Style Images

Next, style transfer with dynamic color control based on two or more style images will be described. As described with reference to FIG. 39, the neural network N5 is trained in two types of color spaces which are the first color space and the second color space. The types of the first color space and the second color space are similar to those in the above description, and thus the description thereof will be omitted.

RGB Optimization

First, RGB optimization will be described. RGB optimization includes style optimization and content optimization. The style optimization function and the content optimization function are as follows.

Style Optimization Function:

$$ℒ \text{?} ( p ) = \sum \text{?} {‖ \frac{G ( {ϕ}_{i} ( p \text{?} ) )}{N \text{?} * N \text{?}} - \frac{1}{2} [ \frac{G ( {ϕ}_{i} ( q \text{?} ) )}{N \text{?} * N \text{?}} + \frac{G ( {ϕ}_{i} ( r \text{?} ) )}{N \text{?} * N \text{?}} ] ‖}_{F}^{2}$$

$$\text{?} ∀ \text{?} ∀ r \text{?} ∈ \hat{S} , r ∈ \hat{S}$$

$$\text{?} \text{indicates text missing or illegible when filed}$$

Content Optimization Function:

$${ℒ}_{c}^{rgb} ( p ) = {\sum }_{j ∈ C} \frac{1}{{U}_{j}} {‖ {ϕ}_{j} ( {p}_{r ℊ b} ) - {ϕ}_{j} ( {c}_{r ℊ b} ) ‖}_{2}^{2}$$

p, Uⱼ, G, φᵢ, φᵢ, S (upper case S), c (lower case c), C (upper case C), F, N_{i,r}, and N_{i,c} have meanings similar to those described with reference to FIGS. 39 to 42.

### \tilde{S}

is a style image group consisting of the plurality of style images, and q and r denote any style images included in the style image group. However, q and r are style images different from each other.

L, p, q, r, and C each having rgb as a subscript indicate the optimization function L for RGB, which is the first color space, the generated image p for RGB, the style image q for RGB, the style image r for RGB, and the content image c for RGB, respectively. L having q and r as subscripts indicates the optimization function L for the two style images q and r selected from a style image group. L having c as a subscript indicates the optimization function L for the content image.

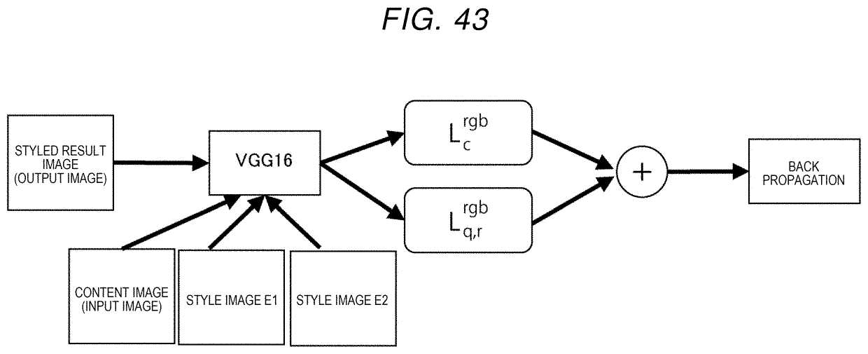

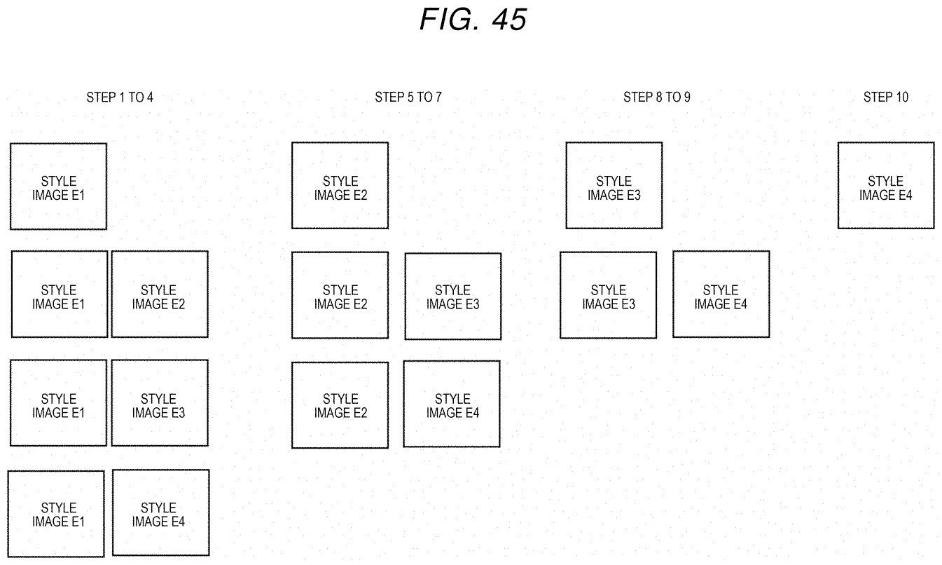

FIG. 43 is a conceptual diagram of an example of calculating the RGB optimization function in the RGB branc, according to at least one embodiment. A styled result image in FIG. 43 corresponds to p_{rgb}. A content image (an input image) in FIG. 43 corresponds to c_{rgb}. Style images E1 and E2 in FIG. 43 correspond to q_{rgb} and r_{rgb}, respectively. The processor adds the value of the style optimization function and the value of the content optimization function, and performs back propagation to minimize the value of the result of the addition. The back propagation will be described later with reference to FIG. 45.

YUV Optimization

Next, YUV optimization will be described. YUV optimization includes style optimization and content optimization. The style optimization function and the content optimization function are as follows.

Style Optimization Function:

$$ℒ \text{?} ( p ) = \sum \text{?} {‖ \frac{G ( {ϕ}_{i} ( p \text{?} ) )}{N \text{?} * N \text{?}} - \frac{1}{2} [ \frac{G ( {ϕ}_{i} ( q \text{?} ) )}{N \text{?} * N \text{?}} + \frac{G ( {ϕ}_{i} ( r \text{?} ) )}{N \text{?} * N \text{?}} ] ‖}_{F}^{2} ; q \neq r$$

$$∀ \text{?} ∀ r \text{?} ∈ \hat{S} , r ∈ \hat{S}$$

$$\text{?} \text{indicates text missing or illegible when filed}$$

Content Optimization Function:

[symbol]

_{c}^{yuvl (}p)= [symbol] _{c}^{y}(p)+ [symbol] _{c}^{uv}(p)

Content Optimization Function (Y loss):

$${ℒ}_{c}^{y} ( p ) = {\sum }_{j ∈ C} \frac{1}{{U}_{j}} {‖ {ϕ}_{j} ( {p}_{y} ) - {ϕ}_{j} ( {c}_{y} ) ‖}_{2}^{2}$$

Content optimization function (UV loss):

$${ℒ}_{c}^{uv} ( p ) = {\sum }_{j ∈ C} \frac{1}{{U}_{j}} {‖ {ϕ}_{j} ( {p}_{uv} ) - {ϕ}_{j} ( {c}_{uv} ) ‖}_{2}^{2}$$

p, Uⱼ, G, φᵢ, φⱼ, S (upper case S), c (lower case c), C (upper case C), F, N_{i, r}, N_{i, c}, q, and r have meanings similar to the description of the RGB optimization in style transfer with dynamic color control based on two or more style images.

Ŝ

is a style image group consisting of a plurality of style images. L, p, q, r, and c each having y as a subscript indicate the optimization function L for a Y channel in YUV that is the second color space, the generated image p for the Y channel, the style image q for the Y channel, the style image r for the Y channel, and the content image c for the Y channel, respectively. L, p, and c each having uv as a subscript indicate the optimization function L for a U channel and a V channel in YUV that is the second color space, the generated image p for the U channel and V channel, and the content image c for the U channel and V channel, respectively. L having q and r as subscripts indicates the optimization function L for the two style images q and r selected from a style image group. L having c as a subscript indicates the optimization function L for the content image.

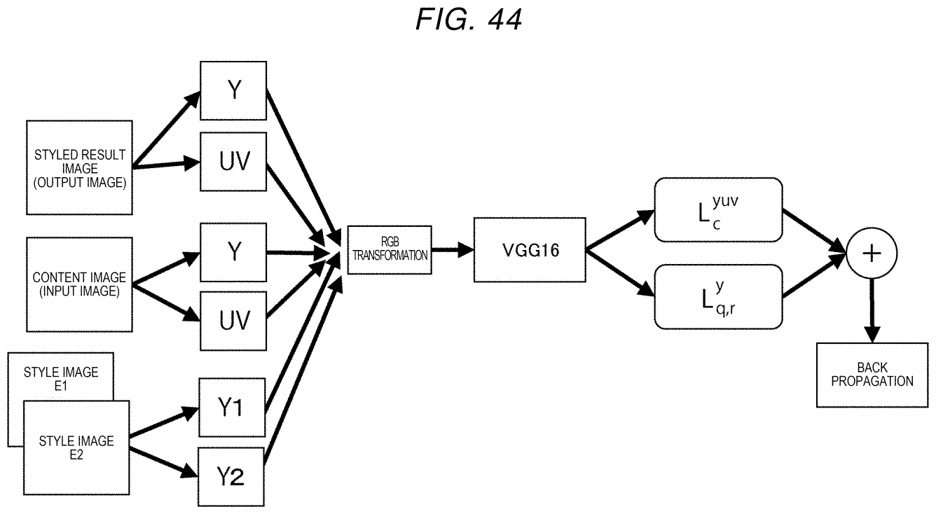

FIG. 44 is a conceptual diagram of an example of calculating the YUV optimization function in the YUV branch according to at least one embodiment. The processor YUV-transforms the styled result image (the output image) and the content image (the input image). Then, the processor extracts the Y channel and the UV channel from the data after transformation, and performs transformation again into RGB. The processor YUV-transforms the style image El and the style image E2. Then, the Y channel is extracted from the data after the transformation, and is transformed again into RGB. The reason for transformation again into RGB is that the subsequent VGG 16 is configured to recognize RGB.

The resultants obtained by YUV-transforming the styled result image (the output image) in FIG. 44 to extract the Y channel and the UV channel, and performing RGB transformation again correspond to p_{y} and pᵤᵥ, respectively. The resultants obtained by YUV-transforming the content image (the input image) in FIG. 44 to extract the Y channel and the UV channel, and performing RGB transformation again correspond to c_{y} and cᵤᵥ, respectively. The resultants obtained by YUV-transforming the style images El and E2 in FIG. 44, extracting the Y channel, and performing RGB transformation again correspond to q_{y} and r_{y}, respectively. The processor adds the value of the style optimization function and the value of the content optimization function, and performs back propagation to minimize the value of the result of the addition. The back propagation will be described later with reference to FIG. 45.

FIG. 45 is a conceptual diagram of the optimization process according to at least one embodiment. The processor adds the value of the style optimization function and the value of the content optimization function to each of the RGB branch and the YUV branch, and performs back propagation to minimize the value of the added result. However, in a case where the number of styles is 2 or more, the value of the style optimization function is not one. For example, when n is an integer of 2 or more, a selection method of selecting any one or two style images from the style image group including n style images is

$${\sum }_{k = 1}^{n} k$$

The processor selects any one or two style images from the style image group and then calculates the value of the style optimization function. In a case where one style image is selected, the equation of the style optimization function described with reference to FIGS. 39 to 42 is used. Since the number of content images is one, the value of the content optimization function is uniquely determined.

The processor adds the calculated value of the style optimization function and the value of the content optimization function, and performs back propagation to minimize the value of the result of the addition. The back propagation is performed by the number of selection methods of selecting any one or two style images from the style image group including n style images.

A specific example will be described. FIG. 45 illustrates a case where the style image group includes n=4 style images. The number of selection methods of selecting any one or two style images from the style image group is 1+2+3+4=10. The processor selects any one or two style images from the style image group and calculates the value of the style optimization function based on the selected style image. The processor adds the value of the style optimization function and the value of the content optimization function, and performs back propagation to minimize the added value. The back propagation process is performed 10 times for the RGB branch and 10 times for the YUV branch, depending on how the style image is selected.

As described above, the processor performs the optimization using optimization functions of two systems of the RGB branch and the YUV branch. The optimization based on the back propagation is performed for the RGB branch and the YUV branch. Thus, training of the neural network N5 based on two or more style images proceeds. The processor may further perform the optimization based on back propagation using the optimization function (the loss function) based on the sum of the values of the optimization functions of the two systems of the RGB branch and the YUV branch. The processor inputs the content image (the input image) to the trained neural network N5, and thus data (that is/are desired image data) obtained by applying the style transfer to the content image is output.

Runtime Color Control

The style transfer unit 102Z may further have a function of controlling the color forming the data formed by the colors between the content color and the style color, based on a predetermined parameter.

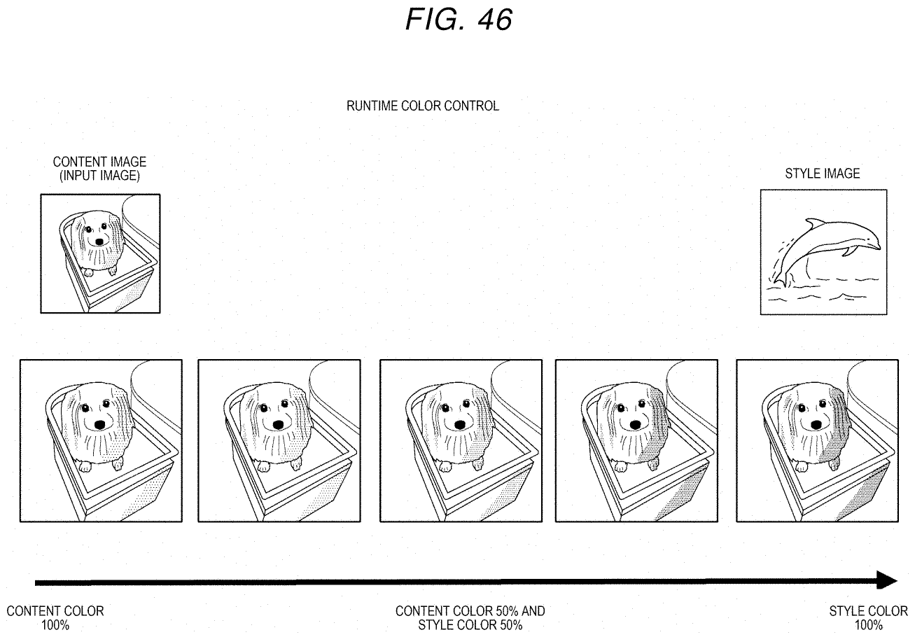

FIG. 46 is a conceptual diagram of an example of the dynamic (or runtime) color control by the processor according to at least one embodiment. In general style transfer, it is possible to transform the style of the content image (the input image) like a style image. However, the colors forming the transformed image are based on the colors forming the style image. According to the style transfer with dynamic color control according to at least one embodiment, it is possible to dynamically control the color forming the output image between the color (the content color) forming the content image, and the color (the style color) forming the style image.

As illustrated in FIG. 46, in the case of style transfer with dynamic color control, it is possible to dynamically control the colors forming the output image from 100% content color to 100% style color.

The style transfer unit 102Z dynamically controls colors in the output image by using the style vectors illustrated in FIGS. 37 and 38. For example, in a case where an input image is transformed into the style of the style image El, and it is desired to obtain an output image having a style color of 80% and a content color of 20%, the style color vector S1 corresponding to the style image E1 and the content color vector S4 are used.

For example, the style transfer unit 1022 calculates scale and bias that are two parameters of affine transformation, as follows.

(scale for dynamic control, bias for dynamic control)=0.8 (scale for S1, bias for S1)+0.2 (scale for S4, bias for S4)

Then, the style transfer unit 1022 performs affine transformation in an affine layer of the neural network N5 by using scale for dynamic control and bias for dynamic control (see FIG. 15).

As described above, the processor calculates scale and bias that are the two parameters of the affine transformation, based on the style vector of the content color and the style vector of the style color. Thus, it is possible to dynamically control the color in the output image after the style transfer.

The color control in the output image after the style transfer may be performed based on a predetermined parameter. For example, in the case of an output image output in a video game, the style transfer unit 1022 may perform dynamical control of the color in a state of setting the ratio (80%: 20% described above, and the like) between the style color and the content color in accordance with predetermined information, for example, the play time of the game, an attribute value such as the physical strength value associated with the character in the game, a value indicating the state of the character such as a buff state or a debuff state, the type of item equipped by the character in the game, an attribute value such as the rarity and magic power grant level associated with the item possessed by the character, and the value corresponding to the predetermined object in the game.

As an aspect of the eighth embodiment, it is possible to obtain an output image obtained by performing style transformation on the original image while a color between a content color being a color forming the original image (the content image) and a style color being a color forming a style image is used as a color forming the output image.

As another aspect of the eighth embodiment, it is possible to dynamically change the color forming the output image between the content color and the style color.

As described above, each embodiment of the present application solves one or two or more deficiencies. Effects of each embodiment are non-limiting effects or an example of effects.

In each embodiment, the user terminal 20 and the server 10 execute the above various processes in accordance with various control programs (for example, the style transfer program) stored in the respective storage devices thereof. In addition, other computers not limited to the user terminal 20 and the server 10 may execute the above various processes in accordance with various control programs (for example, the style transfer program) stored in the respective storage devices thereof.

In addition, the configuration of the video game processing system 100 is not limited to the configurations described as an example of each embodiment. For example, a part or all of the processes described as a process executed by the user terminal may be configured to be executed by the server 10. A part or all of the processes described as a process executed by the server 10 may be configured to be executed by the user terminal 20. In addition, a portion or the entire storage unit (such as the storage device) included in the server 10 may be configured to be included in the user terminal 20. Some or all of the functions included in any one of the user terminal and the server in the video game processing system 100 may be configured to be included in the other.

In addition, the program may be caused to implement a part or all of the functions described as an example of each embodiment in a single apparatus not including the communication network.

Appendix

Certain embodiments of the disclosure have been described for those of ordinary skill in the art to be able to carry out at least the following:

[1] A style transfer program causing a computer to implement: an acquisition function of acquiring image data, a style transfer function of repeatedly applying style transfer to the image data a plurality of times based on one or more style images, and an output function of outputting data after the style transfer is applied.

[2] The style transfer program described in [1], in which in the style transfer function, a function of repeatedly applying the style transfer to the image data based on one or more style images that are the same as style images used in the style transfer applied already to the image data is implemented.

[3] The style transfer program described in [1] or [2], in which in the style transfer function, a function of repeatedly applying the style transfer to the image data based on one or more style images including an image different from an image used in the style transfer applied already to the image data is implemented.

[4] The style transfer program described in any one of [1] to [3], in which the computer is caused to further implement a mask acquisition function of acquiring a mask for suppressing style transfer in a partial region of the image data, and in the style transfer function, a function of applying the style transfer based on one or more style images to the image data by using the mask is implemented.

[5] The style transfer program described in [4], in which in the style transfer function, a function of applying the style transfer to the image data, based on a plurality of styles obtained from a plurality of style images, by using a plurality of the masks for different regions in which the style transfer is suppressed is implemented.

[6] The style transfer program described in [4] or [5], in which in the style transfer function, the style transfer is applied by using the mask for suppressing the style transfer in the partial region that is a corresponding region corresponding to one or more objects included in the image data or a region other than the corresponding region.

[7] The style transfer program described in [6], in which the one or more objects are one or more in-game objects.

[8] The style transfer program described in any one of [4] to [7], in which in the style transfer function, the style transfer is applied by using the mask for suppressing the style transfer in the partial region that is a corresponding region corresponding to one or more effects applied to the image data or a region other than the corresponding region.

[9] The style transfer program described in [8], in which the one or more effects are one or more effects applied to the image data in a game.

[10] The style transfer program described in any one of [4] to [9], in which in the style transfer function, the style transfer is applied by using the mask for suppressing the style transfer in the partial region that is a corresponding region corresponding to a portion in which a pixel value in the image data or buffer data of a buffer related to generation of the image data satisfies a predetermined criterion, or a region other than the corresponding region.

[11] The style transfer program described in any one of [4] to [10], in which in the style transfer function, in a processing layer of a neural network, a function of calculating an average and a standard deviation after applying a hard mask based on the mask to feature value data after convolution, and a function of calculating post-affine transformation feature value data by performing the affine transformation based on one or more first parameters obtained by applying the mask to one or more second parameters for the affine transformation corresponding to a style, the affine transformation being performed on feature value data normalized by using the calculated average and the standard deviation, are implemented.

[12] The style transfer program described in any one of [1] to [11], in which in the style transfer function, a function of applying the style transfer on the image data to output data formed by a color between a content color being a color forming the image data and a style color being a color forming one or more style images to be applied to the image data is further implemented.

[13] The style transfer program described in [12], in which in the style transfer function, a function of controlling, based on a predetermined parameter, a color forming the data formed by the color between the content color and the style color is further implemented.

[14] A server on which the style transfer program described in any one of [1] to [13] is installed.

[15] A computer on which the style transfer program described in any one of [1] to [13] is installed.

[16] A style transfer method including: by a computer, an acquisition process of acquiring image data, a style transfer process of repeatedly applying style transfer to the image data a plurality of times based on one or more style images, and an output process of outputting data after the style transfer is applied.

What is claimed is:

1. A non-transitory computer readable medium storing a program which, when executed, causes a computer to perform processing comprising:
acquiring image data;
applying style transfer to the image data a plurality of times based on one or more style images; and
outputting data after the application of the style transfer.

2. The non-transitory computer readable medium according to claim 1, wherein applying the style transfer includes repeatedly applying first style transfer and second style transfer to the image data, the application of the first style transfer being based on one or more first style images, the application of the second style transfer being based on one or more second style images that are the same as the one or more first style images used in the first style transfer.

3. The non-transitory computer readable medium according to claim 1, wherein applying the style transfer includes repeatedly applying first style transfer and second style transfer to the image data, the application of the first style transfer being based on one or more first style images, the application of the second style transfer being based on one or more second style images including at least one different image from the one or more first style images used in the first style transfer.

4. The non-transitory computer readable medium according to claim 1, wherein
the processing further comprises acquiring a mask for suppressing the style transfer in a partial region of the image data, and
applying the style transfer includes applying the style transfer by using the mask.

5. The non-transitory computer readable medium according to claim 4, wherein
the mask includes a plurality of masks, and
applying the style transfer includes applying the style transfer to the image data based on a plurality of styles obtained from the one or more style images, by using the plurality of masks for suppressing the style transfer in different regions.

6. The non-transitory computer readable medium according to claim 4, wherein the partial region is a first region corresponding to one or more objects included in the image data or a second region different from the first region.

7. The non-transitory computer readable medium according to claim 6, wherein the one or more objects are one or more in-game objects.

8. The non-transitory computer readable medium according to claim 4, wherein the partial region is a first region corresponding to one or more effects applied to the image data or a second region different from the first region.

9. The non-transitory computer readable medium according to claim 8, wherein the one or more effects are one or more effects applied to the image data in a game.

10. The non-transitory computer readable medium according to claim 4, wherein the partial region is a first region corresponding to a portion in which a pixel value in the image data or buffer data of a buffer related to generation of the image data satisfies a predetermined criterion, or a second region different from the first region.

11. The non-transitory computer readable medium according to claim 4, wherein applying the style transfer includes processes to be performed in a processing layer of a neural network, the processes comprise:
applying convolution to feature value data;
applying a hard mask to the feature value data after the convolution, the hard mask being based on the mask;
calculating an average and a standard deviation for the feature value data after the application of the hard mask;
normalizing the feature value data based on the average and the standard deviation;
obtaining one or more first parameters by applying the mask to one or more second parameters for affine transformation corresponding to a style; and
performing the affine transformation based on the one or more first parameters to calculate post-affine transformation feature value data.

12. The non-transitory computer readable medium according to claim 1, wherein applying the style transfer includes applying the style transfer on the image data to output the data formed by a first color between a content color and a style color, the content color forming the image data, the style color forming the one or more style images that are to be applied to the image data.

13. The non-transitory computer readable medium according to claim 12, wherein applying the style transfer includes controlling, based on a predetermined parameter, the first color that forms the data.

14. A method, comprising:
acquiring image data;
applying style transfer to the image data a plurality of times based on one or more style images; and
outputting data after the style transfer is applied.

15. The method according to claim 14, wherein applying the style transfer includes repeatedly applying first style transfer and second style transfer to the image data, the application of the first style transfer being based on one or more first style images, the application of the second style transfer being based on one or more second style images that are the same as the one or more first style images used in the first style transfer.

16. The method according to claim 14, wherein applying the style transfer includes repeatedly applying first style transfer and second style transfer to the image data, the application of the first style transfer being based on one or more first style images, the application of the second style transfer being based on one or more second style images including at least one different image from the one or more first style images used in the first style transfer.

17. The method according to claim 14, wherein
the processing further comprises acquiring a mask for suppressing the style transfer in a partial region of the image data, and
applying the style transfer includes applying the style transfer based on the one or more style images to the image data by using the mask.

18. The method according to claim 14, wherein applying the style transfer includes applying the style transfer on the image data to output the data formed by a first color between a content color and a style color, the content color forming the image data, the style color forming the one or more style images that are to be applied to the image data.
